(19) United States
(12) Patent Application Publication
(10) Pub. No.: US 2014/0303808 A1
(43) Pub. Date: Oct. 9, 2014

(54) SYSTEM FOR DEVICE CONTROL, MONITORING, DATA GATHERING AND DATA ANALYTICS OVER A NETWORK

(71) Applicant: VEEDIMS, LLC, FORT LAUDERDALE, FL (US)

(72) Inventor: ANDREW P. SARGENT, CHITTENDEN, VT (US)

(21) Appl. No.: 14/247,045

(22) Filed: Apr. 7, 2014

Related U.S. Application Data
(60) Provisional application No. 61/828,548, filed on May 29, 2013.
(60) Provisional application No. 61/809,161, filed on Apr. 5, 2013.

(51) Int. Cl. G07C 5/00

(52) U.S. Cl. CPC G07C 5/00
USPC 701/1

(57) ABSTRACT

A system is described for use with an asset such as a vehicle or structure. In one example, the system includes IO modules, a scan module, a vector server, and a historian module. Each IO module includes a local server and is coupled to a component of the asset. Each IO module stores values for variables of the coupled component in the local server and generates a map file containing information about the variables. The scan module accesses each local server and stores the values in an aggregation server. The vector server receives the map file from each IO module and generates a vector file using the map files. The vector file describes the IO modules' variables and identifies each value's memory location in the aggregation server. The historian module generates a storage structure using the vector file and populates the storage structure with the values from the aggregation server.

### CROSS-REFERENCE TO RELATED APPLICATIONS

This application claims the benefit of U.S. Provisional No. 61/809,161, filed on Apr. 5, 2013, and entitled SYSTEM FOR DEVICE CONTROL, MONITORING, DATA GATHERING AND DATA ANALYTICS OVER A NETWORK (Atty. Dkt. No. VLLC-31676), and U.S. Provisional No. 61/828,548, filed on May 29, 2013, and entitled SYSTEM AND METHOD FOR DATA MANAGEMENT (Atty. Dkt. No. VLLC-31731), both of which are incorporated herein in their entirety.

### TECHNICAL FIELD

The present application is directed to a data management system for assets and, more specifically, to controlling, monitoring, data gathering, and data analytics for one or more vehicles.

### BACKGROUND

Asset monitoring systems currently in use fail to adequately collect and manage information pertaining to assets such as vehicle or structures. Accordingly, improvements in such systems are needed.

### SUMMARY

In one embodiment, a system includes a plurality of input/output (IO) modules, a scan module, a vector server, and an asset historian module. The IO modules are positioned within a vehicle. Each IO module includes a local server and is coupled to at least one component of the vehicle. Each IO module is configured to store values for variables of the coupled component in the IO module's local server and to generate a map file containing information about the variables. The scan module is positioned within the vehicle and coupled to the local servers and an aggregation server. The scan module is configured to access each local server and to store the values contained in each local server in the aggregation server. The vector server is positioned within the vehicle and coupled to the IO modules and the scan module. The vector server is configured to receive the map file from each IO module and to generate a vector file based on the map files. The vector file describes the variables for the plurality of IO modules and identifies a location for each of the values in a memory of the aggregation server. The asset historian module is positioned within the vehicle and coupled to the vector server and the aggregation server. The asset historian module contains a local historian database and is configured to generate a storage structure within the local historian database based on the vector file and to populate the storage structure with the values from the aggregation server.

In another embodiment, the system further includes a tag builder that is configured to automatically generate a tag for each of the variables based on the vector file, wherein a tag is a defined structure within the local historian database. In another embodiment, the tag builder is further configured to determine whether a change has occurred to the plurality of modules and, if a change has occurred, is configured to update the storage structure to reflect the change. In another embodiment, the tag builder is configured to determine whether the change has occurred by polling the vector server. In another embodiment, the tag builder is configured to determine whether the change has occurred by evaluating a checksum of the vector file. In another embodiment, only the scan module and the IO modules can directly access the local servers. In another embodiment, the scan module provides an application programming interface for access to the aggregation server because access to a value within the aggregation server requires knowledge of a location of the value in the memory of the aggregation server, and wherein the scan server is configured to receive a query for a variable name from an application, match the variable name to the location of the corresponding value in the memory of the aggregation server, and to return the value to the application. In another embodiment, the scan module is configured to provide an event subscription interface, wherein a change in a value stored in a local server that corresponds to a subscribed event is published by the scan module to any subscriber of the subscribed event. In another embodiment, a system definition file defines a behavior of the vector server and the scan module. In another embodiment, the system definition file defines which of the variables for the IO modules should be described in the vector file. In another embodiment, the system definition file defines which of the values contained in each local server should be stored in the aggregation server. In another embodiment, the system further includes a fleet historian module positioned outside of the vehicle, wherein the fleet historian module contains a fleet historian database that contains information from the storage structures of a plurality of vehicles.

In still another embodiment, a method for managing data for a vehicle is provided. The method includes generating a plurality of map files by a corresponding plurality of IO modules positioned within the vehicle. Each IO module is coupled to at least one component of the vehicle. The map file generated by each IO module contains information about variables corresponding to the component coupled to the IO module. A vector file is generated from the plurality of map files. The vector file describes the variables and identifies where a value for each variable is located in a memory of an aggregation server positioned within the vehicle. A local data structure for the vehicle is automatically created in a local historian database positioned within the vehicle using the variables in the vector file. The local data structure is populated with the values from the aggregation server. The local data structure is automatically updated as changes occur to the vector file and the values.

In another embodiment, the method further includes storing the value for each of the variables in the aggregation server, wherein the storing includes: retrieving the value from the IO module corresponding to the component coupled to the IO module; and storing the value in the aggregation server. In another embodiment, the method further includes creating a physical model structure of the vehicle using the vector file and the values; and sending the physical model structure to a fleet historian that is located outside of the vehicle. In another embodiment, the method further includes using a system definition file to control which of the variables are described in the vector file.

In yet another embodiment, a method for installing a data management system for a plurality of vehicles is provided. The method includes creating a registration for each of the vehicles at a fleet level. A cloned image of a local information management structure is created on each of the vehicles. The cloned image of the local information management structure is modified on each of the vehicles to make the local information management structure on each vehicle unique to that vehicle. A plurality of data points needed for each local information management structure are automatically generated based on a vector file generated within the vehicle corresponding to the local information management structure. The vector file describes a plurality of modules positioned within the vehicle, a plurality of variables corresponding to each of the modules, and a location of each of a plurality of values corresponding to the variables. Each of the local information management structures is populated with the values from the vehicle corresponding to the local information management structure. Each of the local information management structures is linked with the registration of the vehicle corresponding to the local information management structure.

In another embodiment, the method further includes creating a fleet information management structure that contains data from the local information management structures of each vehicle. In another embodiment, the method further includes importing a physical model structure of each vehicle into the fleet information management structure. In another embodiment, the physical model structure contains context information for each data point, and the context information is not stored in the local information management structures.

### BRIEF DESCRIPTION OF THE DRAWINGS

For a more complete understanding, reference is now made to the following description taken in conjunction with the accompanying Drawings in which:

FIG. 1 illustrates one embodiment of an architecture for information accumulation and management with asset and fleet levels;

FIG. 2 illustrates one embodiment of a configuration of the architecture of FIG. 1 within an asset;

FIG. 3 illustrates a more detailed embodiment of a portion of the architecture of FIG. 1 within an asset;

FIG. 4A illustrates one embodiment of a portion of the architecture of FIG. 1;

FIG. 4B illustrates one embodiment of a method that may be used by a VIO module within the architecture of FIG. 4A;

FIG. 4C illustrates one embodiment of a method that may be used by a vector server within the architecture of FIG. 4A;

FIG. 4D illustrates one embodiment of a method that may be used by a Vscan module within the architecture of FIG. 4A;

FIGS. 5-8 illustrate various embodiments of portions of the architecture of FIG. 1;

FIG. 9 illustrates one embodiment of a method that may be used to install various functions described herein within the architecture of FIG. 1;

FIG. 10 illustrates one embodiment of a graphical user interface showing an asset framework database physical model;

FIG. 11 illustrates one embodiment of a graphical user interface showing a mapping of an asset down to individual raw data;

FIG. 12 illustrates one embodiment of a graphical user interface showing trip records of assets;

FIG. 13 illustrates one embodiment of a graphical user interface showing asset displays for diagnostics;

FIG. 14 illustrates one embodiment of an implementation process for historians within the architecture of FIG. 1;

FIG. 15 illustrates one embodiment of a graphical user interface for a data entry screen that may be used during an installation process to create new manufacturers and capture contact information;

FIG. 16 illustrates one embodiment of a graphical user interface for a data entry screen that may be used during an installation process to create new asset types;

FIG. 17 illustrates one embodiment of a graphical user interface for a data entry screen that may be used during an installation process to create new asset models;

FIG. 18 illustrates one embodiment of a graphical user interface for a data entry screen that may be used during an installation process to register assets and enter asset specifications;

FIG. 19 illustrates one embodiment of a graphical user interface showing an asset tag naming convention;

FIG. 20 illustrates one embodiment of a graphical user interface showing a structure for an asset; and

FIG. 21 illustrates one embodiment of a method that may be used by a configuration service within the architecture of FIG. 1.

### DETAILED DESCRIPTION

Referring now to the drawings, wherein like reference numbers are used herein to designate like elements throughout, the various views and embodiments of system and method for device control, monitoring, data gathering and data analytics over a network are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

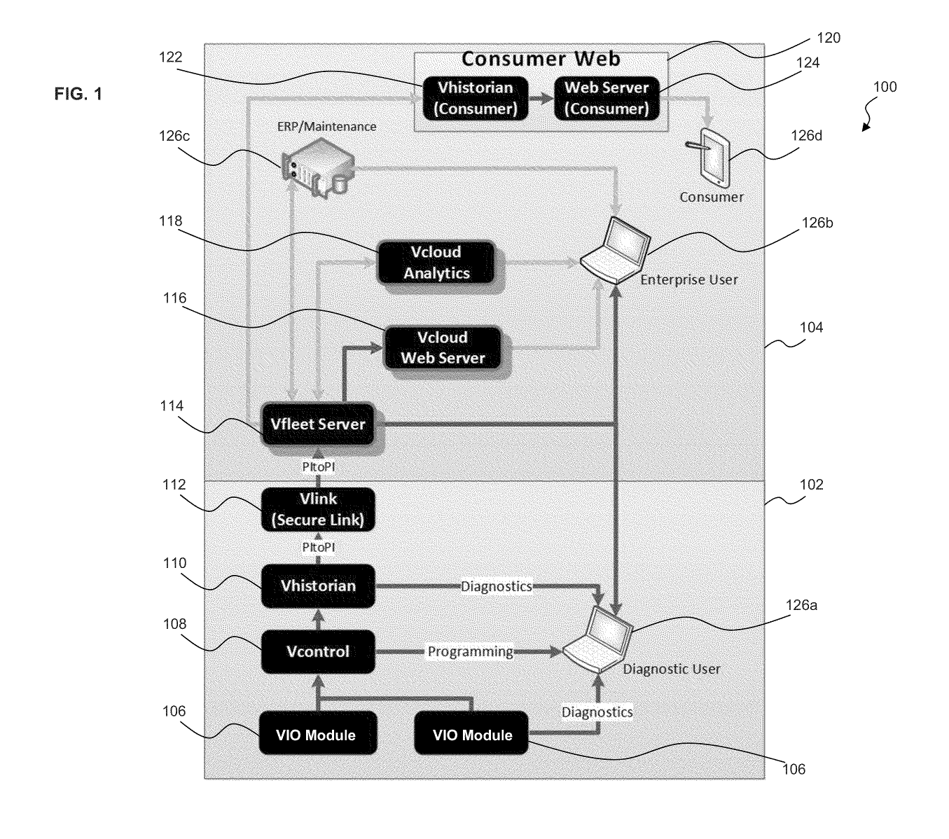

Referring to FIG. 1, one embodiment of an architecture 100 is illustrated. The architecture 100 includes an information accumulation and management system for one or more assets 102 and a fleet system 104. Each asset 102 may be a vehicle or a structure.

The term “vehicle” may include any artificial mechanical or electromechanical system capable of movement (e.g., motorcycles, automobiles, trucks, boats, and aircraft), while the term “structure” may include any artificial system that is not capable of movement. Although both a vehicle and a structure are used in the present disclosure for purposes of example, it is understood that the teachings of the disclosure may be applied to many different environments and variations within a particular environment. Accordingly, the present disclosure may be applied to vehicles and structures in land environments, including manned and remotely controlled land vehicles, as well as above ground and underground structures. The present disclosure may also be applied to vehicles and structures in marine environments, including ships and other manned and remotely controlled vehicles and stationary structures (e.g., oil platforms and submersed research facilities) designed for use on or under water. The present disclosure may also be applied to vehicles and structures in aerospace environments, including manned and remotely controlled aircraft, spacecraft, and satellites.

The architecture 100 enables real-time and/or cached information to be obtained about the asset 102 and some or all of this information to be sent to the fleet system 104. The information includes both metadata and values corresponding to the metadata. For example, metadata may describe that a variable named “fuel level” is associated with a fuel delivery system and a value may indicate the actual fuel level (e.g., the amount of available fuel). The metadata may also include other information, such as how the fuel delivery system interacts with other systems within the asset 102.

To accomplish this, the asset 102 includes one or more VIO modules 106 (e.g., input/output modules). Each VIO module 106 is coupled to one or more components (not shown) of the asset 102. Examples of such modules and connections to various components are described in U.S. Pat. No. 7,940,673, filed Jun. 6, 2008, and entitled “System for integrating a plurality of modules using a power/data backbone network,” which is hereby incorporated by reference in its entirety. Each component is associated with one or more variables and each variable may have one or more values. The VIO modules 106 are responsible for gathering and storing the values and reporting the metadata to a Vcontrol module 108.

The Vcontrol module 108 may provide direct and/or cached access to the values stored by the VIO modules 106. The Vcontrol module 108 also receives the metadata from the VIO modules 106 and republishes the metadata for consumers within the architecture 100, such as a Vhistorian module 110. The Vhistorian module 110 provides a storage structure for the values based on the metadata and sends this structure and/or other information to the fleet system 104 via a Vlink module 112 that provides a communications interface for the asset portion of the architecture 100.

A Vfleet server 114 communicates with the Vhistorian module 110. In some embodiments, the Vfleet server 114 may contain a Vhistorian that stores information for multiple assets, while in other embodiments the fleet level Vhistorian may be elsewhere (e.g., in a Vcloud web server 116). Vcloud analytics 118 may perform various analyses on data obtained via the Vfleet server 114. In some embodiments, consumer web functionality 120 may be provided using a consumer Vhistorian 122 accessed through a consumer web server 124. The consumer Vhistorian 122 may provide access only to fleet level information that the consumer has permission to access.

Various devices 126a-126d may interact with the environment 100 for purposes such as programming, diagnostics, maintenance, and information retrieval. It is understood that the devices 126a-126d and their corresponding communication paths and access points are for purposes of example only, and there may be many different ways to access components within the environment 100.

It is understood that the functionality described with respect to FIG. 1 and other embodiments herein may be combined or distributed in many different ways from a hardware and/or software perspective. For example, the functionality of the Vcontrol module 108 and Vhistorian module 110 may be combined onto a single platform or the functionality of the Vcontrol module 108 may be further divided into multiple platforms. Accordingly, while the functionality described herein is generally tied to a particular platform (e.g., the Vcontrol module 108 and the Vhistorian module 110 may be on separate physical devices), this is for purposes of convenience and clarity and is not intended to be limiting. Furthermore, the internal structure of a module may be implemented in many different ways to accomplish the described functionality.

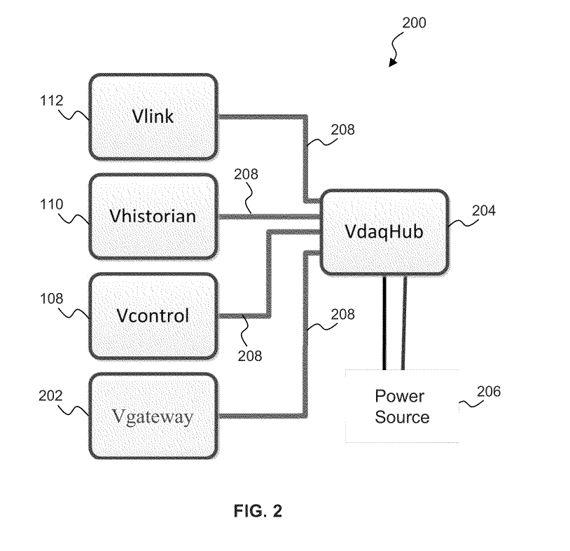

Referring to FIG. 2, an embodiment of one configuration 200 of the architecture 100 within the asset 102 of FIG. 1 is illustrated. Functionality for modules that has been discussed with respect to FIG. 1 may not be discussed in detail in the present example. The Vcontrol module 108 is a system controller. The Vhistorian module 110 may be an embedded server, such as a PI server provided by OSIsoft, LLC, of San Leandro, Calif., although many different types of servers and server configurations may be used. The Vlink module 112 is a communications interface, such as a 4G data uplink with secure Wireless Local Area Network (WLAN) and Global Positioning System (GPS) functionality.

A Vgateway module 202 is illustrated in addition to the Vcontrol module 108, Vhistorian module 110, and Vlink module 112. In the present example, the Vgateway module 202 is a configurable gateway that supports device communication functionality such as CAN++, NMEA 2000, and/or Modbus. In some embodiments, the Vlink module 112 and the Vgateway module 202 may be combined. In other embodiments, the Vgateway module 202 may be part of a VIO module 106.

A VdaqHub module 204 may be used as a power and data distribution hub that is coupled to a power source 206. The configuration 200 may use cables 208 that carry both power and data, simplifying the wiring within the asset 102. In some embodiments, various components within the asset 102 may pass through power and/or data, further simplifying the wiring. Examples of such a cable and its application are described in previously incorporated U.S. Pat. No. 7,940,673, and in U.S. Pat. No. 7,740,501, filed Jun. 6, 2008, and entitled “Hybrid cable for conveying data and power,” which is hereby incorporated by reference in its entirety.

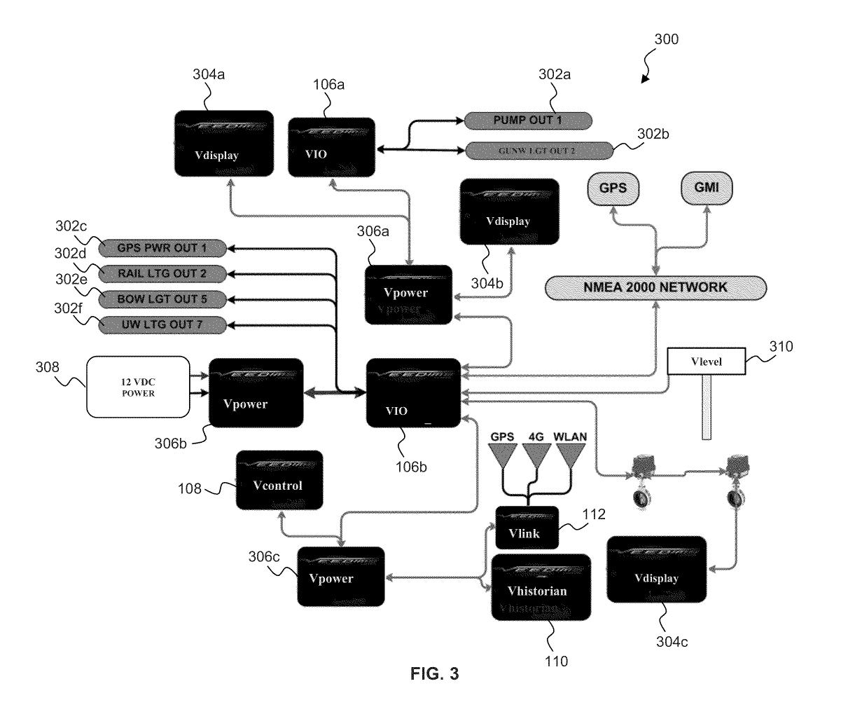

Referring to FIG. 3, one embodiment of an architecture 300 illustrates a more detailed example of a portion of the architecture within the asset 102 of FIG. 1, which is a boat in the present example. In the present example, the boat 102 includes various modules, such as VIO modules 106a and 106b, Vcontrol module 108, Vhistorian module 110, Vlink module 112, Vdisplay modules 304a-304c, and Vpower modules 306a-306c (which may be similar or identical to the VdaqHub module 204 of FIG. 2 in some embodiments).

The VIO module 106a is coupled to various components of the boat 102, such as pump 302a and gunwale lighting 302b, while the VIO module 106b is coupled to GPS power 306c, rail lighting 306d, bow lighting 306e, underwater lighting 306f, and Vlevel 310. VIO module 106b may also provide access to a network within the asset 102 such as an NMEA 2000 network for GPS and GMI connectivity. Vdisplays 304a-304c, which may include displays such as high resolution touchscreens, may be configured to show information from the other modules (e.g., pump operation and lighting status) and/or to provide a control interface to enable control over the various components. Vpower modules 306a-306c provide power. Vcontrol module 108, Vhistorian module 110, and Vlink module 112 provide functionality as previously described.

The architecture 300 enables various functions of the asset 102 (e.g., the boat) to be monitored, controlled, and logged using a single integrated system rather than many different systems that do not communicate with one another. Accordingly, the architecture 300 enables a cleaner approach that reduces or even eliminates issues caused by the use of many different systems while also providing improved information management capabilities.

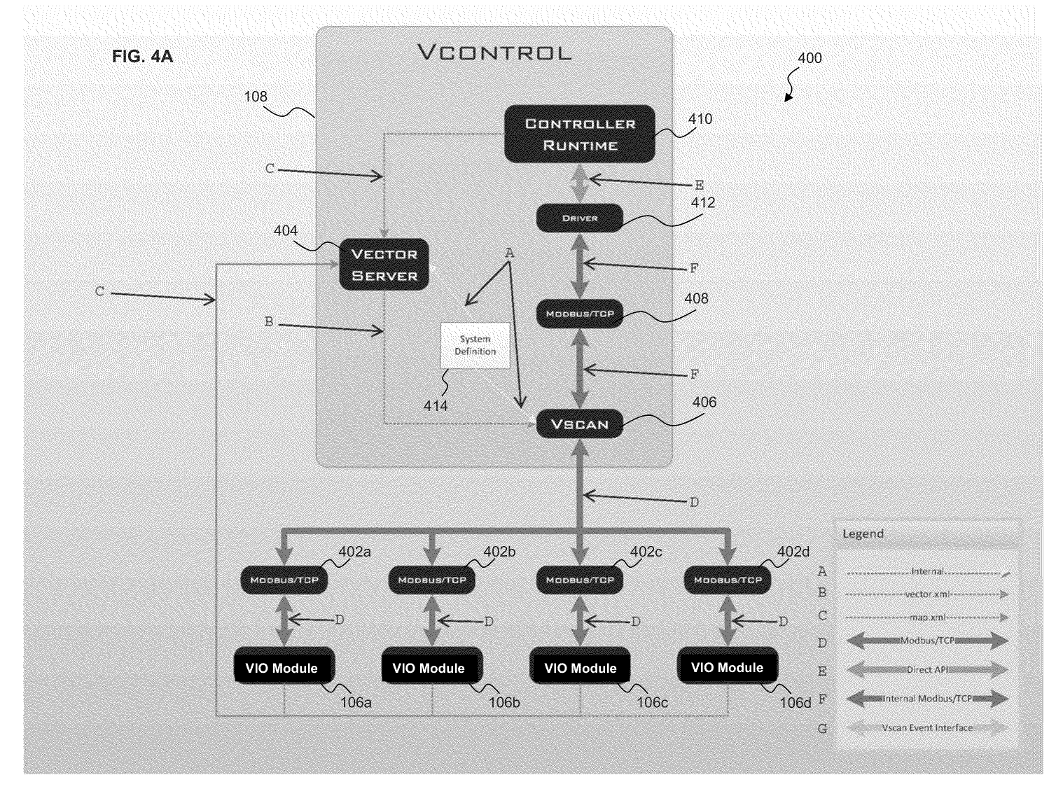

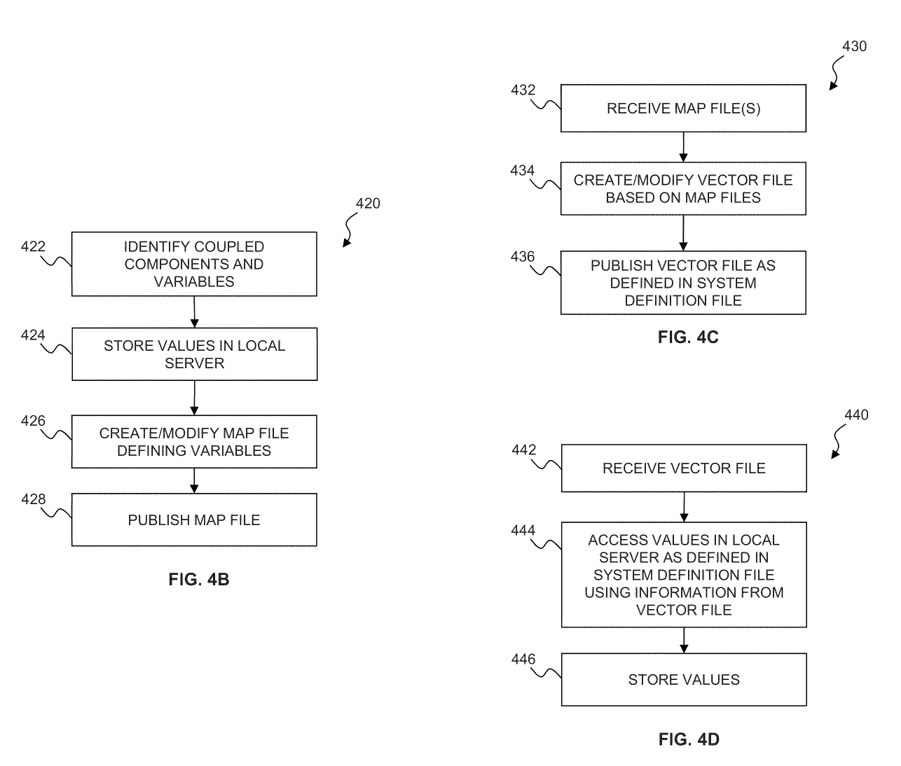

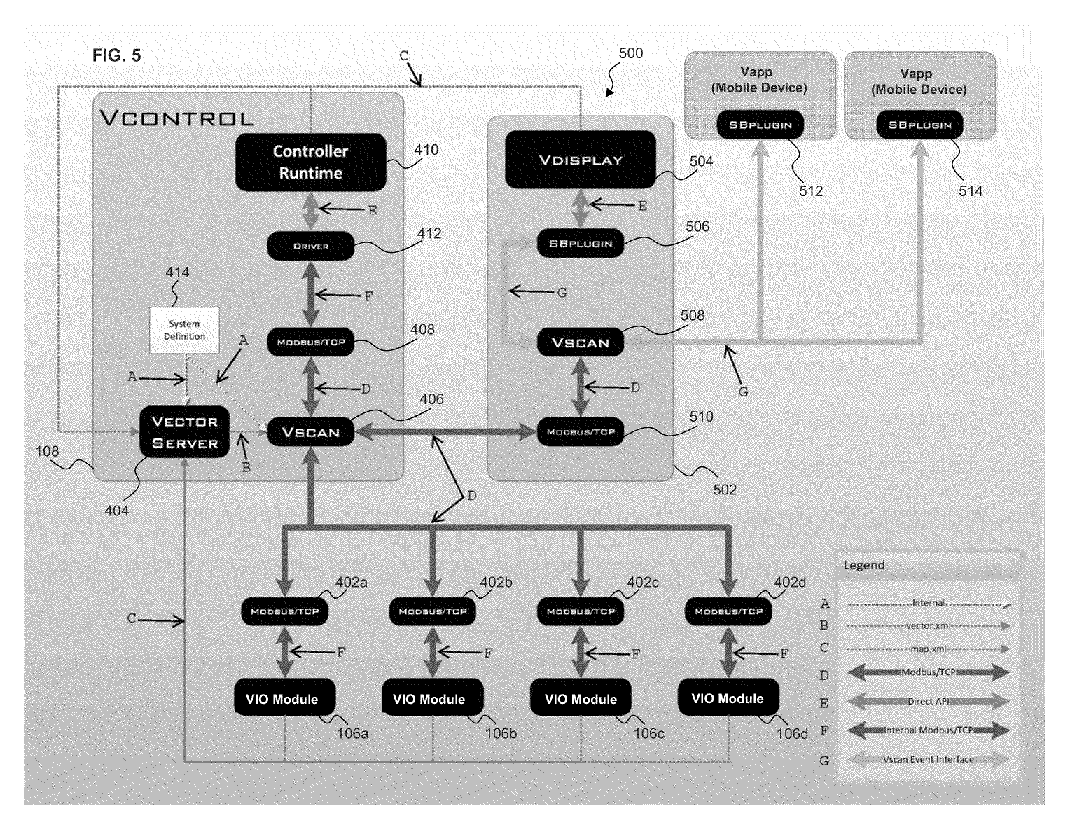

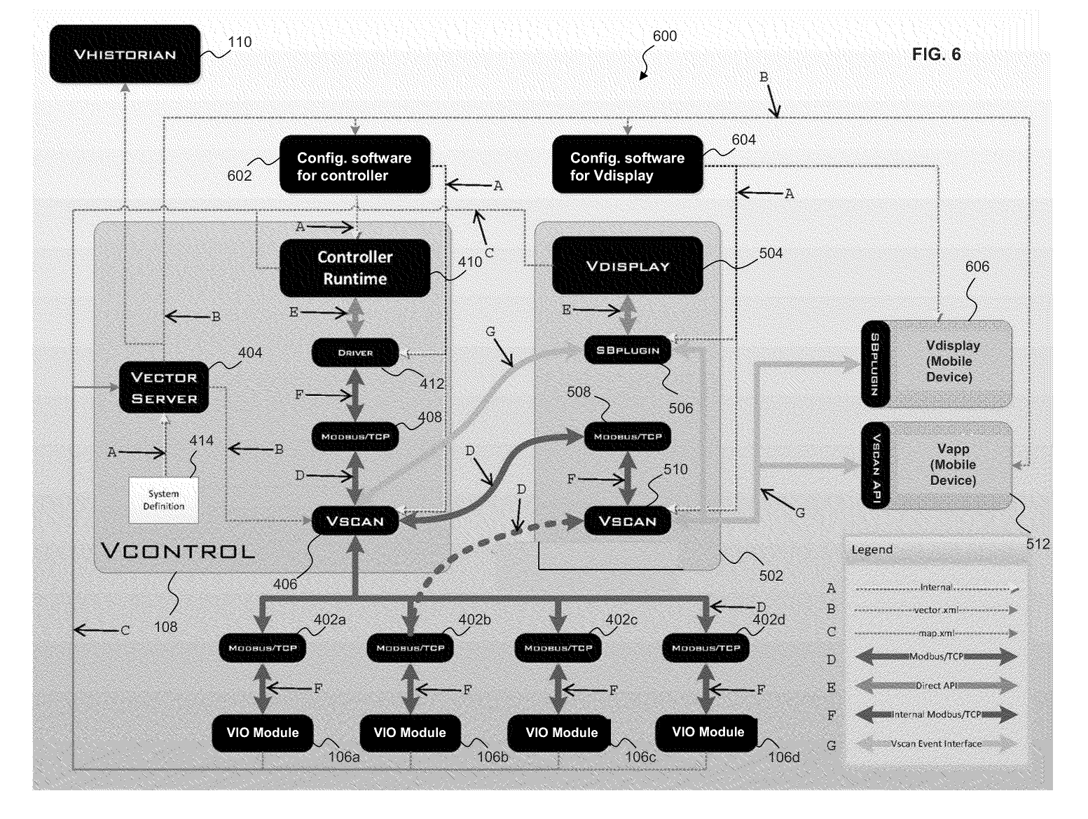

Referring to FIG. 4A, one embodiment of an architecture 400 illustrates a more detailed example of a portion of the architecture within the asset 102 of FIG. 1. More specifically, VIO modules 106a-106d and Vcontrol module 108 are illustrated. The architecture 400 makes use of two different types of files, which are named map.xml and vector.xml in the present example. It is understood that other file types may be used and that the use of extensible markup language (XML) files is for purposes of example only. Furthermore, each file may be divided into multiple files in some embodiments.

With additional reference to FIG. 4B, a method 420 illustrates one embodiment of a process that may be used with a VIO module 106a-106d within the architecture 400 of FIG. 4A. Each VIO module 106a-106d is coupled to one or more components of the asset 102, as described previously. Accordingly, in step 422 of FIG. 4B, each VIO module scans and identifies any coupled components, as well as any variables for those components. This scanning may occur at regular intervals to determine if a change has occurred (e.g., if a component has been modified, removed, or added) and/or may occur based on an event (e.g., a notification from a component).

Each VIO module 106a-106d includes or is coupled to a local server 402a-402d, respectively. For purposes of example, each local server 402a-402d is a Modbus TCP server that provides register space for sixteen bit words and there is a dedicated Modbus TCP server 402a-402d for each VIO module 106a-106d. As illustrated in step 424 of FIG. 4B, each VIO module 106a-106d stores information in the corresponding Modbus TCP server 402a-402d, such as values for variables of the VIO module itself and of any components of the asset 102 coupled to that particular VIO module. For example, in FIG. 3, VIO module 106a would store variable values for pump 302a and gunwale lighting 306b in the Modbus TCP server 402a that corresponds to the VIO module 106a. Also in FIG. 3, VIO module 106b would store variable values for GPS power 306c, rail lighting 306d, bow lighting 306e, underwater lighting 306f, and Vlevel 310 in the Modbus TCP server 402b that corresponds to the VIO module 106b.

The information stored by a VIO module 106a-106d may be static and/or dynamic. For example, information identifying a particular VIO module 106a-106d might be static unless manually changed, while measurement values (e.g., pressure, voltage, speed, and status) from coupled components would be dynamic as the values may change over time. As illustrated by FIG. 426 of FIG. 4B, each VIO module 106a-106d produces a map.xml file detailing the variables corresponding to the VIO module. The map.xml file may include the memory location of each value in the Modbus TCP server 402a-402d. The map.xml file is then published to the vector server 404, as illustrated in step 428 of FIG. 4B.

Accordingly, for each VIO module 106a-106d, actual variable values are stored in the corresponding Modbus TCP server 402a-402d and metadata for the VIO module is provided in the generated map.xml file. It is understood that this may be implemented differently in other embodiments and, for example, the metadata and values may be stored in a single location, such as the Modbus TCP server 402a-402d.

With additional reference to FIG. 4C, a method 430 illustrates one embodiment of a process that may be used with the Vcontrol module 108 within the architecture 400 of FIG. 4A. The Vcontrol module 108 includes a vector server 404, a Vscan component 406, a server 408 (e.g., a Modbus TCP server that may or may not be combined with the Vscan component 406), a controller runtime 410, and a driver 412 that enables the controller runtime 410 to communicate with the Modbus TCP server 408.

In the present example, the method 430 of FIG. 4C is executed by the vector server 404. As illustrated in step 432, the vector server 404 receives the map.xml files from each VIO module 106a-106d and from other modules (e.g., the controller runtime 410 of the Vcontrol module 108). The vector server 404 compiles the map.xml files into a single vector.xml file, as shown by step 434. The vector.xml file may then be published for various consumers, such as the Vscan 406, as shown by step 436.

In some cases, one or more map.xml files may be received after the initial vector.xml file has been published. For example, if a change to a VIO module 106a-106d has occurred (e.g., component has been modified, added, or removed), only that map.xml file may be received by the vector server 404 during a particular period of time. The vector server 404 may then publish this change by either modifying the existing vector.xml file and republishing it, or by publishing only the changed portion of the vector.xml file. The information published in the vector.xml file may be tailored based on various report formats.

In one report format, the vector.xml file contains the details of each VIO module 106a-106d and information about each of the VIO module's variables. Such information may include, but is not limited to, whether a variable is an input, the name of the variable, how many registers are used for the variable, where the variable is located in register space in the Modbus TCP server 402a-402d in which the variable is stored, the type of variable (e.g., signed or unsigned), whether the variable is user viewable or diagnostic only, a description of the variable, a list for valid values for the variable, information to tell less complex devices how to read the data, and/or other information.

In another report format, the vector.xml file may provide a list of the VIO modules 106 and their current discovered status. For example, this format may list the location of each VIO module 106a-106d, when each VIO module 106a-106d was last scanned for its map.xml file, the checksum for the map.xml file, and/or other information. This report format may be used primarily to help detect changes and maintain the system. In the present example, the vector.xml file does not contain values for the variables, although such values may be included in the vector.xml file in other embodiments.

With additional reference to FIG. 4D, the Vscan 406 is the only component of the architecture that interacts directly with the Modbus TCP servers 402a-402d in the configuration of FIG. 4A. In other words, if a variable value for a particular VIO module 106a-106d is stored in the corresponding Modbus TCP server 402a-402d, the only component other than the VIO module itself that can access the variable is the Vscan 406 in this embodiment. It is understood that other modules may be able to directly access the Modbus TCP servers 402a-402d in other embodiments. The Vscan 406 is configured to support multiple ways for other components to access the data. Accordingly, Vscan 406 maintains a separate cached version of some or all of the information from the various Modbus TCP servers 402a-402d, provides an event subscription interface for access to the information, and provides an application programming interface (API) for access to the information. It is understood that one or more of the described functions may be moved to another component.

As illustrated in step 442 of FIG. 4D, Vscan 406 receives the vector.xml file from the vector server 404, which informs the Vscan 406 where each value is located in a particular Modbus TCP server 402a-402d. To provide the cached version of the information, Vscan 406 retrieves some or all of the values from the various Modbus TCP servers 402a-402d (step 444 of FIG. 4D) and stores the information in the Modbus TCP server 408 (step 446 of FIG. 4D). This provides a copy of the values that can be accessed without going to the VIO modules 106a-106d. Updated values that do not need to be retrieved in real time can then be obtained by other modules from the Modbus TCP server 408, which reduces overhead on the VIO modules 106a-106d.

For example, the Vhistorian module 110 may poll the Modbus TCP server 408 for updates. As the Vhistorian module 110 likely does not need updates in real time, pulling the information via polling may adequately refresh the information for its needs. Furthermore, polling may be advantageous as polling is deterministic (e.g., the network load can be calculated and managed) and resilient to errors because if a variable update is missed it will be picked up the next time. However, polling may not be as useful for Vdisplay and other applications that need updates in real time or near real time.

To access the information via the event subscription interface, Vscan 406 provides an interface to which various applications may subscribe. When an event occurs, Vscan 406 sends out a notification to all the subscribers for that particular event. As with the cached version, this reduces overhead on the VIO modules 106a-106d as multiple components can receive an update notification following a single access by Vscan 406 of a Modbus TCP server 402a-402d.

To access the information via the API provided by Vscan 406, an application can make a simple request (e.g., by variable name) to Vscan 406, and Vscan 406 will access the Modbus TCP server 408 and return the requested information. This simplifies the process from the perspective of the requesting application, as only basic information needs to be known. More specifically, the Modbus TCP server 408, like the Modbus TCP servers 402a-402d, stores information in registers. To access a particular variable, the location of that variable within the Modbus TCP server 408 must be known. In other words, access requires knowledge of which particular register or registers contain the desired information. Vscan 406 has this knowledge due to the vector.xml file received from the vector server 404 and can perform the lookup without needing the application to specify the register(s). Vscan 406 can then return the value or values to the requesting application.

In some embodiments, Vscan 406 may also provide direct access to the VIO modules 106a-106d. For example, high speed applications that need real time or near real time updates may access the Modbus TCP servers 402a-402d either directly or via Vscan 406 to obtain the information. In some embodiments, Vscan 406 may also be used to write to a VIO module 106a-106d. For example, an update can be sent to Vscan 406 and Vscan can then update the VIO module 106a-106d via the Modbus TCP link.

One or more system definition files 414 may be used to control the behavior of the vector server 404 and/or Vscan 406. For example, the system definition file 414 may define what variables the Vscan 406 is to retrieve from the Modbus TCP servers 402a-402d and/or what metadata should be published by the vector server 404 in the vector.xml file.

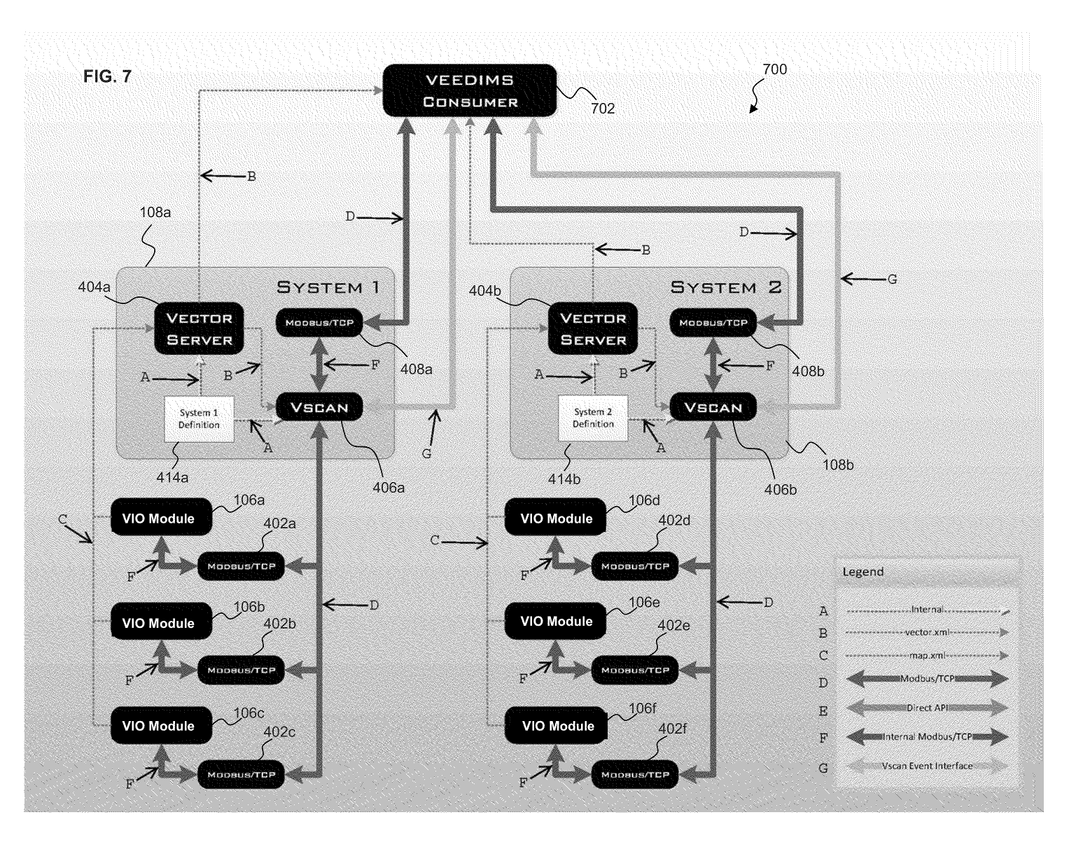

Referring to FIG. 5, one embodiment of an architecture 500 illustrates a more detailed example of a portion of the architecture within the asset 102 of FIG. 1. More specifically, VIO modules 106a-106d and Vcontrol module 108 of FIG. 4A are illustrated. In addition, FIG. 5 illustrates Vdisplay module 502 and mobile device applications (Vapp) 512 and 514. The VIO modules 106a-106d, Modbus TCP servers 402a-402d, and Vcontrol module 108 are similar or identical to those discussed previously (e.g., with respect to FIG. 4A) and are not discussed in detail in the present embodiment with respect to previously described functionality. It is noted that, as a module within the architecture 500, the Vdisplay module 502 sends a map.xml file to the vector server 404 for use in the vector.xml file.

The Vdisplay 502 enables information to be displayed to a user. The information may include metadata obtained from the vector.xml file published by the Vcontrol module 108 and/or values for variables contained in the Modbus TCP server 408. To accomplish this, the Vdisplay module 502 includes a Vdisplay 504 (e.g., display logic and other functionality), a plugin/driver 506, a Vscan 508, and a server 510 (e.g., a Modbus TCP server). The plugin/driver 506 enables the Vdisplay 504 to communicate with the Vscan 508.

The Modbus TCP server 510 contains some or all of the values that are in the Modbus TCP server 408. These values are provided to the Modbus TCP server 510 by the Vscan 406. For example, the system definition file 414 may instruct the Vscan 406 to copy one or more values to the Modbus TCP server 510. In other embodiments, the Vscan 508 may communicate with the Vscan 406 and/or the Modbus TCP server 408 in order to copy the values into the Modbus TCP server 510. In some embodiments, the Vscan 508 may communicate directly with the Modbus TCP servers 402a-402d to obtain this information, although a system definition file (not shown) may be needed in such embodiments or the system definition file 414 may be extended to include the Vscan 508.

In the present embodiment, the mobile device Vapps 512 and 514 interact with Vscan 508 using the previously described event system. The plugin 506 may also use the event system with Vscan 508.

Referring to FIG. 6, one embodiment of an architecture 600 illustrates a more detailed example of a portion of the architecture within the asset 102 of FIG. 1. More specifically, VIO modules 106a-106d, Vcontrol module 108, and Vdisplay module 502 of FIG. 5 are illustrated with the Vhistorian module 110. In addition, FIG. 6 illustrates configuration software 602 (e.g., Multiprog) for Vcontrol module 108, configuration software 604 (e.g., Storyboard) for Vdisplay module 502, and a mobile device Vdisplay 606. The VIO modules 106a-106d, Modbus TCP servers 402a-402d, Vcontrol module 108, and Vdisplay module 502 are similar or identical to those discussed previously (e.g., with respect to FIG. 5) and are not discussed in detail in the present embodiment with respect to previously described functionality.

In the present embodiment, the plugin/driver 506 enables the Vdisplay 502 to communicate with the configuration software 514, as well as with the Vscan 406 and/or the Vscan 508.

The Modbus TCP server 510 contains some or all of the values that are in the Modbus TCP server 408. These values are provided to the Modbus TCP server 510 by the Vscan 406. For example, the configuration software 512 may configure the Vscan 406 to copy one or more values to the Modbus TCP server 510. In other embodiments, the Vscan 508 may communicate with the Vscan 406 and/or the Modbus TCP server 408 in order to copy the values into the Modbus TCP server 510. In some embodiments, the Vscan 508 may communicate directly with the Modbus TCP servers 402 to obtain this information, although a system definition file (not shown) may be needed in such embodiments or the system definition file 414 may be extended to include the Vscan 508.

In the present embodiment, the mobile device Vdisplay 606 and Vapp 512 interact with Vscan 508 using the previously described event system. The plugin 506 may also use the event system with Vscan 508 and/or Vscan 406.

It is noted that the vector.xml file may be published to Vscan 406, Vhistorian 110, configuration software 602 and 604, and Vapp 518. The configuration software 602 and 604 may use information from the vector.xml file to configure their respective plugin/drivers and Vscan components. The Vapp 512 may use information from the vector.xml file to identify which variable values it can request via the Vscan API.

Referring to FIG. 7, one embodiment of an architecture 700 illustrates a more detailed example of a portion of the architecture within the asset 102 of FIG. 1. More specifically, the architecture 700 uses the basic structure of the Vcontrol module 108 of FIG. 4A with VIO modules 106a-106f, but uses two Vcontrol modules 108a and 108b that each control a portion of the VIO modules 106a-106f. A consumer 702 (e.g., a Vhistorian, a Vdisplay, and/or another consumer) may then interact with the architecture 700 as previously described. In some embodiments, the architecture 700 may provide failover support so that a Vcontrol module can take over if part or all of another Vcontrol module fails.

In operation, the system definition files 414a and 414b may be used to control which VIO modules 106a-106f are to be associated with each of the Vcontrol modules 108a and 108b and Vscans 406a and 406b. The Vscans 406a and 406b only access their assigned VIO modules 106a-106f. For example, the Vscan 406a accesses only the VIO modules 106a-106c and the Vscan 406b accesses only the VIO modules 106d-106f. It is understood that each Vscan 406a and 406b may have Modbus TCP access to all of the VIO modules 106a-106f in some embodiments, even if they are configured to access only their assigned modules.

Each vector server 404a and 404b receives the map.xml files from the VIO modules associated with that vector server. For example, the vector server 404a receives map.xml files from the VIO modules 106a-106c, and the vector server 404b receives map.xml files from the VIO modules 106d-106f. In the present embodiment, each vector server 404a and 404b receives only the map.xml files from the corresponding VIO modules 106a-106c and 106d-106f, respectively. In other embodiments, each vector server may receive all of the map.xml files and discard or ignore (e.g., save but not use) the map files for which it is not responsible. This may be particular useful in failover applications, but increases the amount of network traffic and processing required by each vector server.

Each vector server 404a and 404b then generates its own vector.xml file and publishes the file for its corresponding Vscan 406a or 406b and the consumer 702. In other embodiments, the vector servers 404a and 404b may also publish their respective vector.xml files to each other and/or to the other's Vscan. The consumer 702 can then use the vector.xml files to determine which of the Vscan 406a, Vscan 406b, Modbus TCP server 408a, or Modbus TCP server 408b should be accessed to retrieve particular information.

Referring to FIG. 8, one embodiment of an architecture 800 illustrates a more detailed example of a portion of the architecture 100 of FIG. 1. More specifically, VIO modules 106a-106d and Vcontrol module 108 of FIG. 4A are illustrated with the Vhistorian module 110. In addition, FIG. 8 illustrates a portion of the Vfleet system 104. The VIO modules 106a-106d, Modbus TCP servers 402a-402d, and Vcontrol module 108 are similar or identical to those discussed previously (e.g., with respect to FIG. 4A) and are not discussed in detail in the present embodiment with respect to previously described functionality.

The Vhistorian module 110, which is located in the asset 102 in the present embodiment, includes an auto tag builder 802, a Vhistorian 804 that contains logic and a database, a driver 806 that couples the Vhistorian 804 to the Modbus TCP server 408, and an interface 808 that enables synchronization between the Vhistorian 804 and a Vhistorian 810 in the fleet system 104. In the present example, which uses a PI server structure, the interface is a PI2PI interface.

In operation, the auto tag builder 802 receives the vector.xml file from the vector server 404. The auto tag builder 802 generates tags (e.g., variable labels) needed for the data structure provided by the Vhistorian 804 based on the vector.xml file. This process is described in detail below. Once the data structure has been built, the Vhistorian 804 accesses the Modbus TCP server 408 via the driver 806 and populates the data structure with the values stored in the Modbus TCP server 408. The data structure and/or additional information can then be transferred to the Vhistorian 810 via the interface 808.

It is noted that the content of Vhistorian module 110 (which may be referred to herein as an asset Vhistorian) and the Vhistorian 810 (which may be referred to herein as a Vfleet historian or a fleet Vhistorian) may be the same from a tag standpoint. For example, both Vhistorians would contain a particular data point, such as a data point for engine temperature. However, the Vhistorian 810 will generally contain much more data than the Vhistorian module 110. This is because the Vhistorian 810 is a compilation of many asset Vhistorians and also contains additional information for a particular asset that the asset itself may not contain, such as information identifying a particular asset (e.g., a registration number) and information about the structure of a particular vehicle. For example, the Vhistorian module 110 in the asset 102 may have a data point for engine temperature, but may not contain the concept that the engine temperature belongs to a structure called “engine system.” The Vhistorian 810 does have this conceptual relationship information for purposes such as analytics. It is noted that this may vary depending on the particular implementation and the Vhistorian module 110 may also have this information in some embodiments.

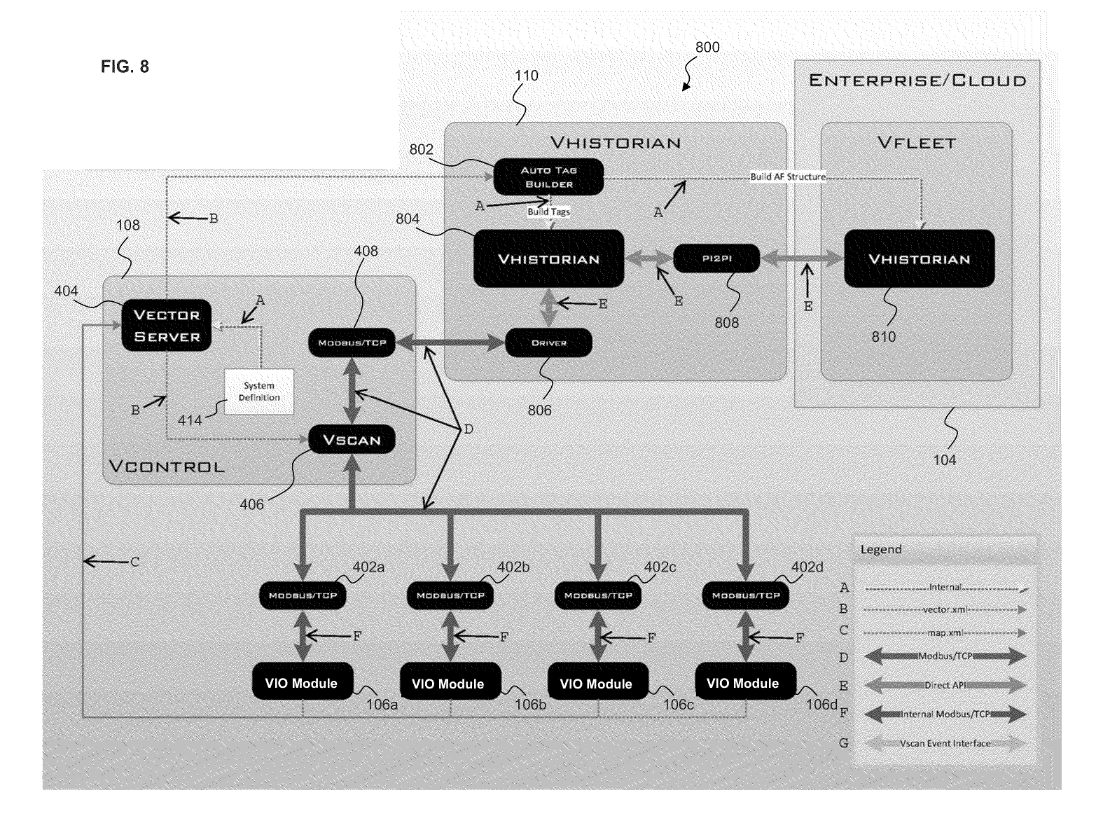

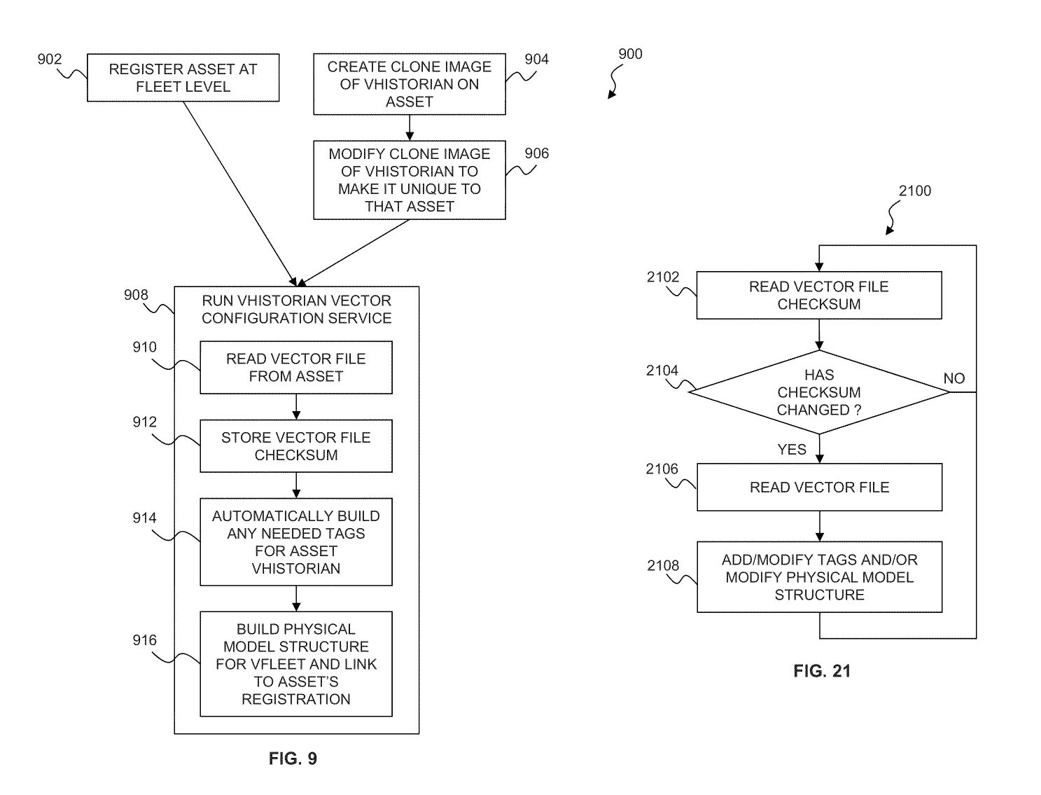

Referring to FIG. 9 and with additional reference to FIGS. 10-20, the following embodiments describe a particular implementation of the architecture 100 of FIG. 1 using custom components in conjunction with products of OSIsoft, LLC, of San Leandro, Calif. FIG. 9 illustrates one embodiment of a method 900, while FIGS. 10-20 illustrate various aspects of the method 900 and/or various aspect of the functionality resulting from installation. It is understood that this particular implementation is for purposes of example only and that many different systems and system components may be used to implement the architecture 100.

The implementation process results in the asset Vhistorian (e.g., the Vhistorian module 110) being automatically configured to collect all raw data from all modules in the asset 102. This means that raw data collection points (e.g., OSIsoft “PI Tags”) are automatically created from the Vcontrol module's configuration whenever points are created or changed. In addition, data is automatically stored in the asset Vhistorian's database.

Data from the asset Vhistorian is replicated up to the fleet system's Vhistorian database (e.g., the Vhistorian module 810) in a data center or a customer installation on demand or at a regular interval depending on need and link availability. Even when the link is down, the asset Vhistorian stores its data locally and any data gaps in the Vfleet historian are backfilled on reconnection of the link. This transfer is over a secure link provided by the Vlink module 112 that manages the hard, wireless, cellular, and/or satellite connections. Security may be provided by Sonicwall VPN security, RSA, and/or other security options depending on end user requirements.

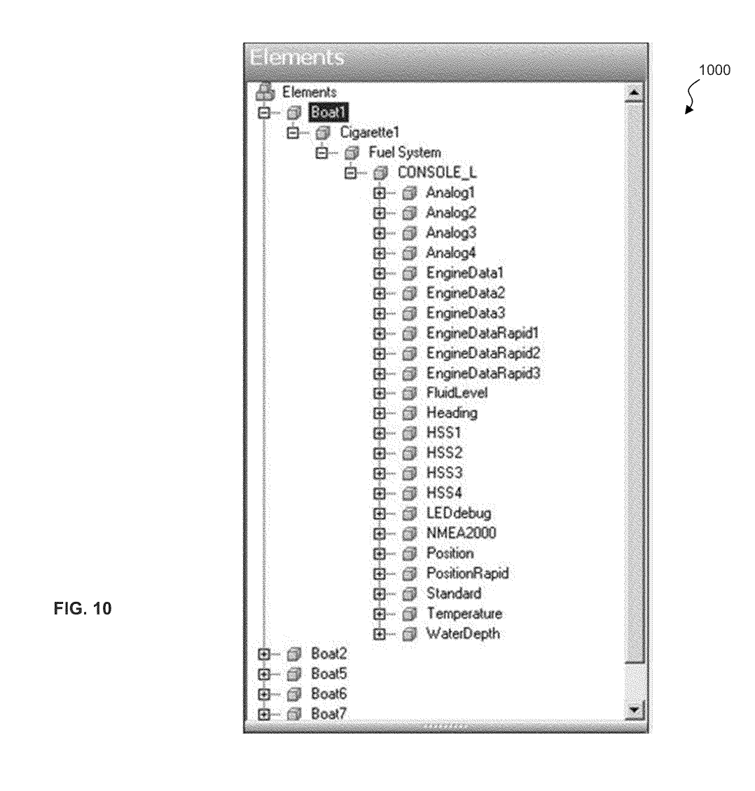

When each new asset (e.g., vehicle or structure) is registered with the Vfleet historian, the Vcontrol module 108 and associated VScan component 406 and Modbus TCP server 408 supply the information used to build a physical model of the deployed system on the Vfleet historian to provide a consistent and easy to navigate view of all the modules and data. This is illustrated by a graphical user interface (GUI) 1000 in FIG. 10, which shows a PI Asset Framework Database Physical Model that is automatically created, and a GUI 1100 of FIG. 11, which shows that the Vfleet historian contains the mapping of all assets down to individual raw data. In the case of FIG. 11, the asset is a boat named “Boat1” and the model can be traced to the current selection that shows the details of “Engine Temperature.”

Even though each asset's data is stored on one Vfleet historian, individual raw data is uniquely identified but can be easily retrieved across a fleet using common alias names.

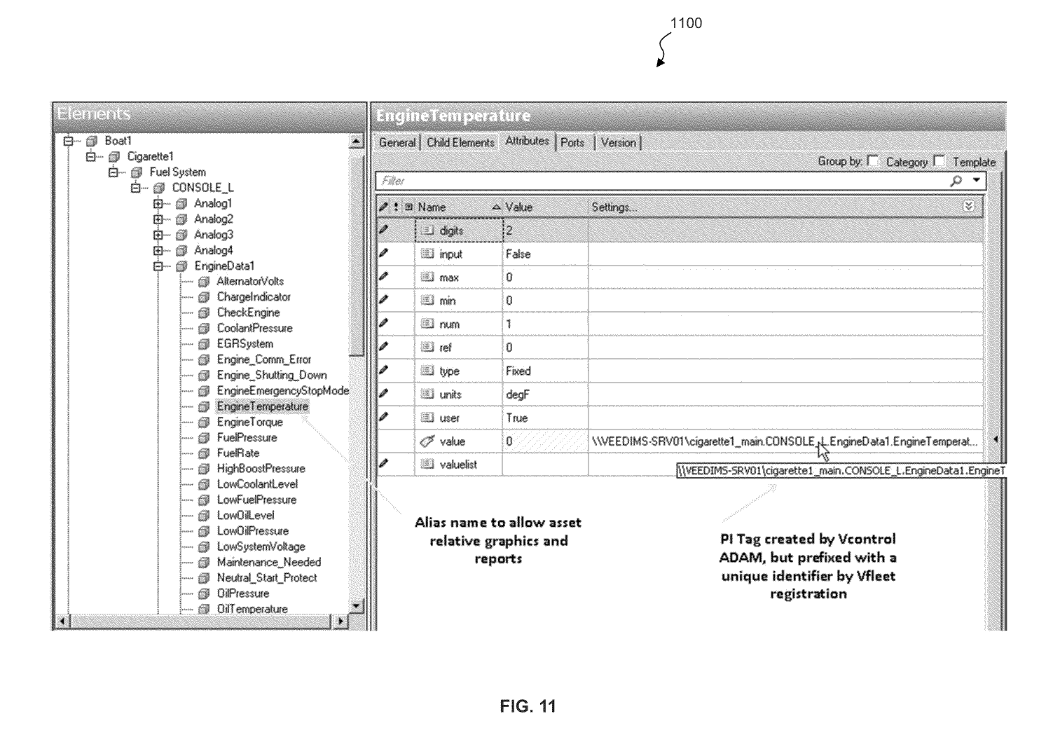

At the Vfleet historian, the data is analyzed and batched to produce “runs” or “trips”for each vehicle or other batch categories. Trips can be determined from configurable combinational “events” such as engine rotations per minute (rpms) and torque rising together. These trips are recorded as “Event Frame” records on the Vfleet historian. This is illustrated in a GUI 1200 of FIG. 12, which shows that the Vfleet historian contains the trip records of all vehicles.

The Vfleet historian makes available the asset data and aliasing using standard OSIsoft PI trend and analysis tools that include thick client tools such as OSIsoft PI Process Book and web based diagnostic tools and trends such as OSIsoft PI WebParts. All data is available at this level subject to user privileges and credentials. OSIsoft PI tools have built-in functions that enable them to be used to navigate the fleet level model and the data organized in the PI Asset Framework.

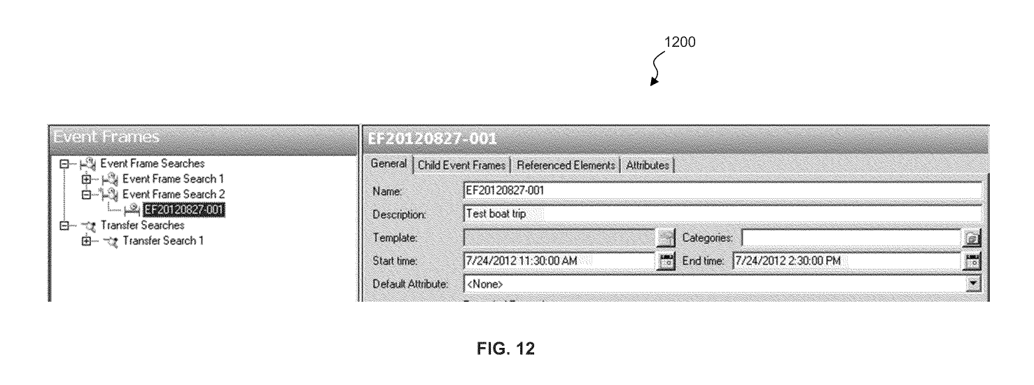

Diagnostic/local users can have access to real-time and historical data directly on the network illustrated in FIG. 1. Diagnostic displays and reports can be built from the physical model using standard OSIsoft products using “asset relativity.” In other words, one display will work across all vehicles of that asset class and the engineer simply picks the asset he needs to work on. Built-in trend and analysis functions allow engineers to dig deeply and troubleshoot each asset. This is illustrated in a GUI 1300 of FIG. 13, which shows that engineers are provided with standard sets of asset displays for diagnostics in PI ProcessBook.

These same displays, or variants of them, can easily be made available to Enterprise users via the standard OSIsoft PI Web Part tools by a save and publish function. This means the display configuration is only done once.

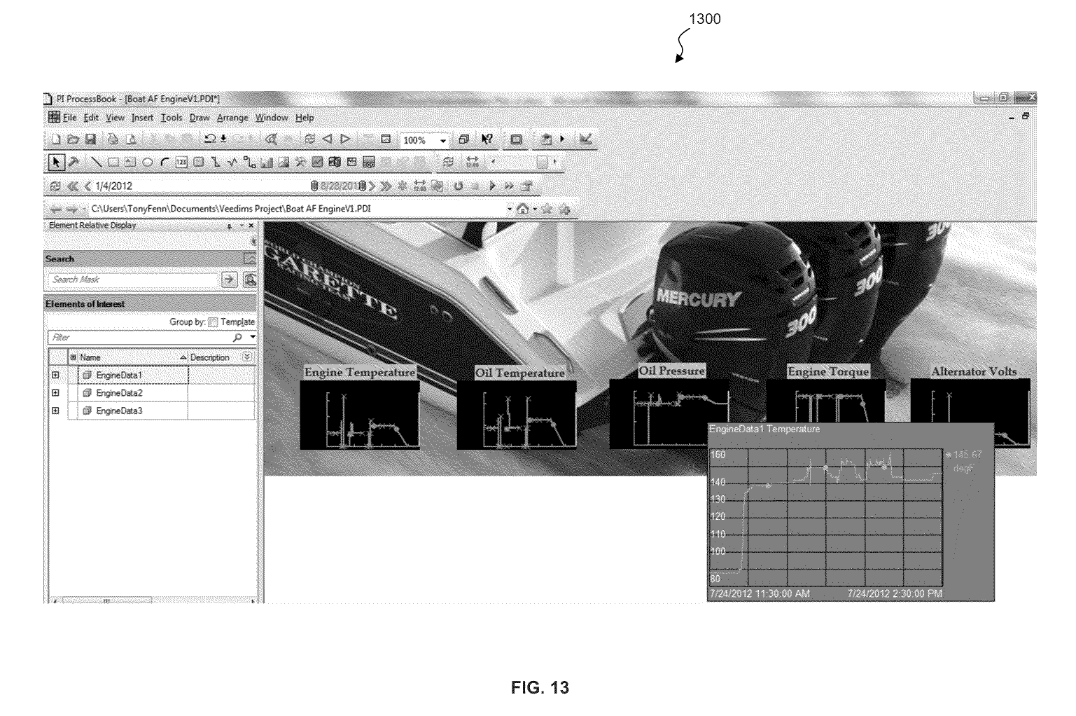

With reference to FIG. 14, there are two levels of historians, the Vfleet historian at the fleet system level (Vfleet PI Db) and then an asset Vhistorian at each asset/vehicle level (Vhistorian PI Db). For purposes of example, the Vfleet historian server is installed in the Data Center on a Windows 2008 Server and includes the OSIsoft PI Server and PI AF Server. It is sized to handle multiple asset tag sets, initially ten thousand tags. This may be provided as a single PI Server instance or may be configured as an OSIsoft Highly Available pair, which may be particularly useful when deployed to support customer data and potentially customer remote access.

The Vfleet historian server may also have Microsoft Sharepoint installed to support the building of enterprise dashboards using OSIsoft PI Web Parts.

For purposes of example, the following OSIsoft PI components may be on a Vfleet historian server: PI Server Database, PI AF Server Database, PI AF Process Explorer, PI Web Parts, PI SDK 32 bit and 64 bit (supports PI Web Services), PI Web Services, PI System Management Tools, PI Process Book, and PI DataLink.

As illustrated by step 902 of FIG. 9, each new asset must be registered at the fleet level. When a new asset (e.g., a car, a boat, a bus, or a truck) is to be deployed, then it must be registered at the Vfleet level so that the asset can be tracked uniquely and its asset Vhistorian can be installed automatically.

A set of Vfleet registration screens allows an administrator to create sets of database entities to describe the individual asset as belonging to various categories, such as manufacturer, asset type, and asset model. For example, the boat of FIG. 3 may be a Contender (manufacturer), Boat (asset type), and “30 Tournament Fishing” (asset model).

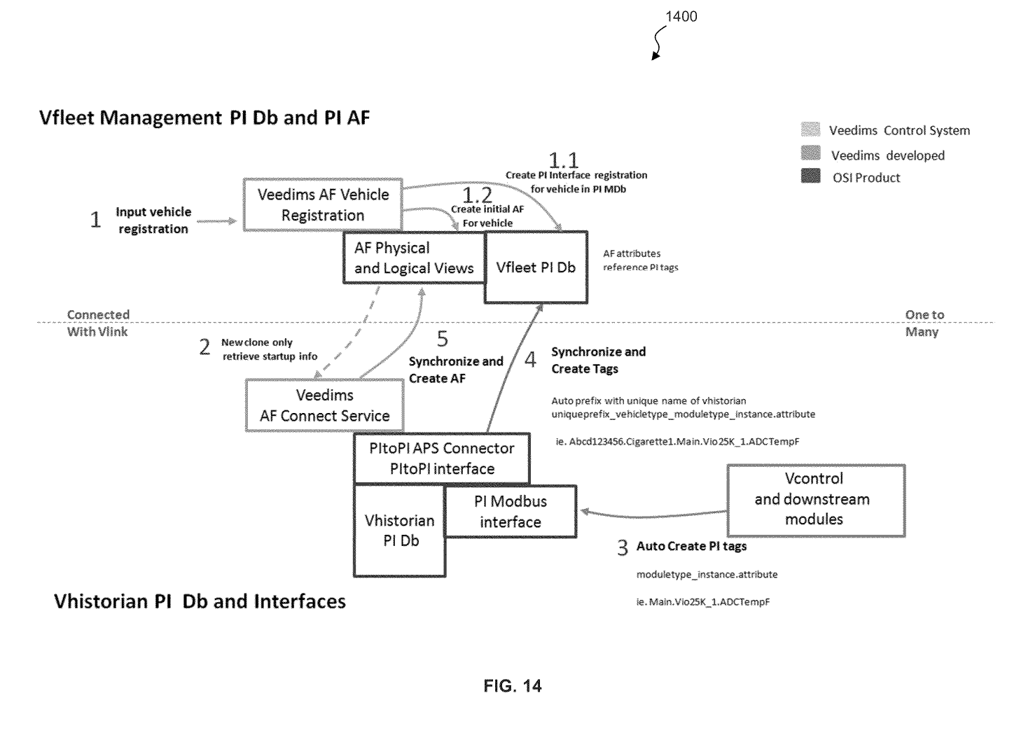

Referring to a GUI 1500 of FIG. 15, one embodiment of a data entry screen is illustrated that may be used to create new manufacturers and capture contact information.

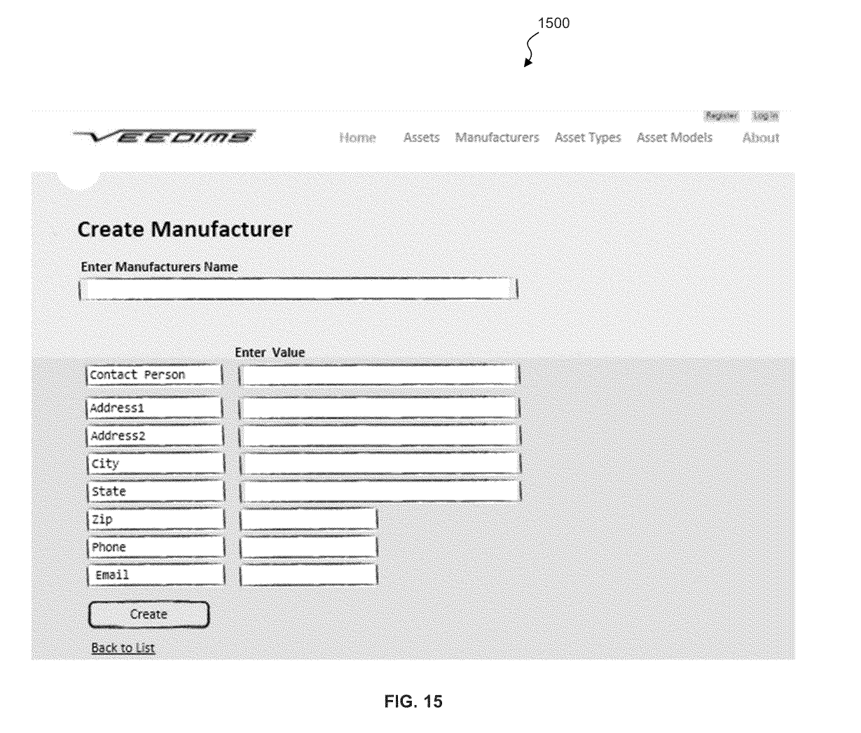

Referring to a GUI 1600 of FIG. 16, one embodiment of a data entry screen is illustrated that may be used to create new asset types such as boat, car, or bus.

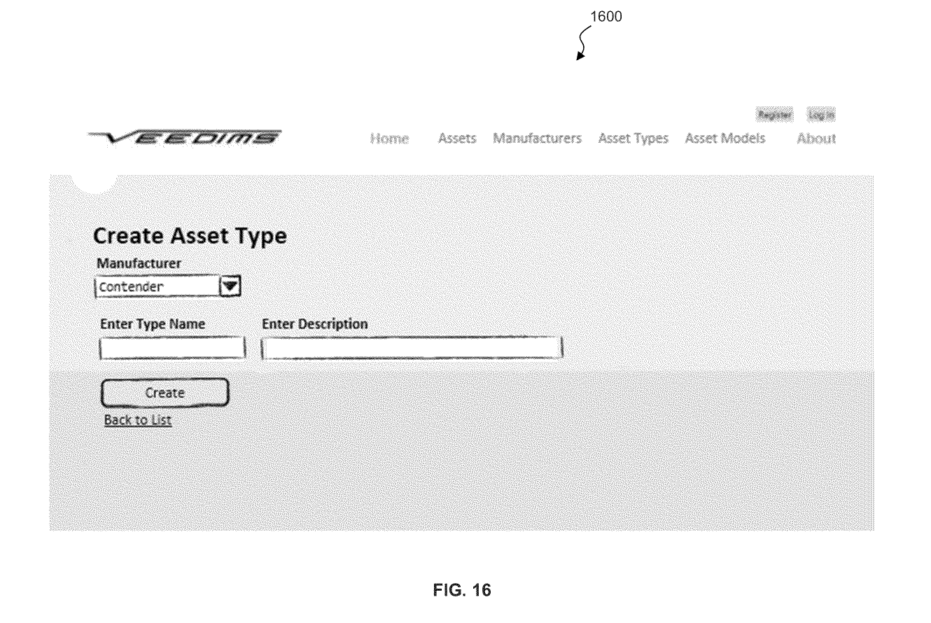

Referring to a GUI 1700 of FIG. 17, one embodiment of a data entry screen is illustrated that may be used to create new asset models such as “30 Tournament Fishing” or “Explorer.” Specifications can also be entered to describe each model.

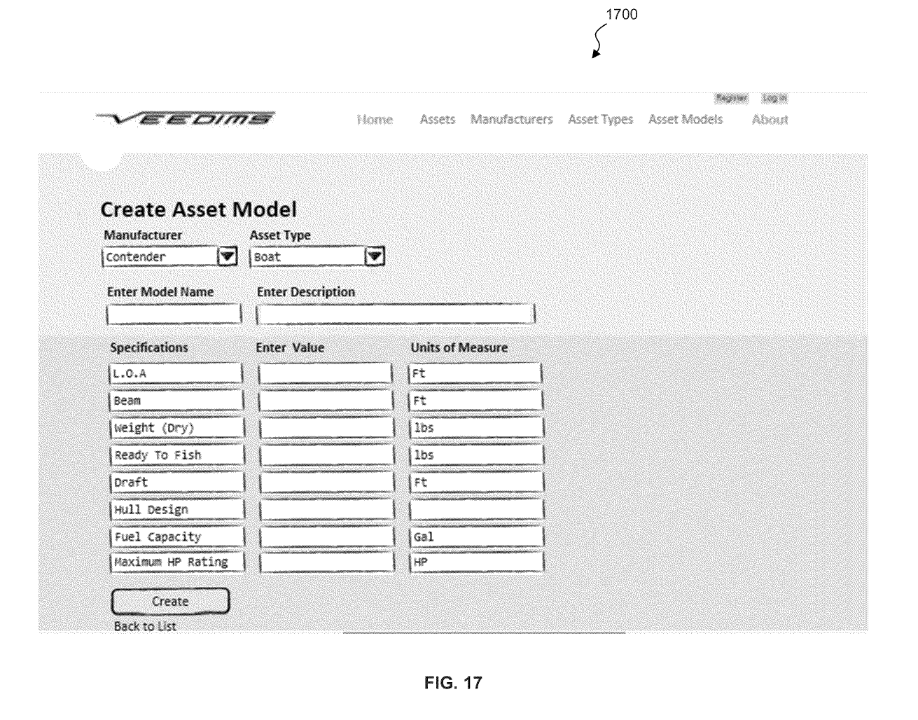

Referring to a GUI 1800 of FIG. 18, one embodiment of a data entry screen is illustrated showing that assets can be registered in the context of the pre-built manufacturer/asset type/asset model structure and asset specifications can be entered.

Note that when an asset is to be created, then its asset Vhistorian is identified using its computer's media access control (MAC) address, but with the dashes removed. For example, if a computer's MAC address is 0E-3A-5D-F6-B4, then the entered value will be 0E3A5DF6B4

When the create button is pressed on the create asset screen, several Vfleet registration tasks occur.

First, there is the creation of a ‘registration’ structure of manufacturer/asset type/asset model/asset in the Vfleet PI AF Server database with the details of the asset instance. This structure is a ‘root’ where, at a later point, the physical model of the asset's modules and associated sensors can be created and tracked. This is illustrated in FIG. 14 by step 1.2.

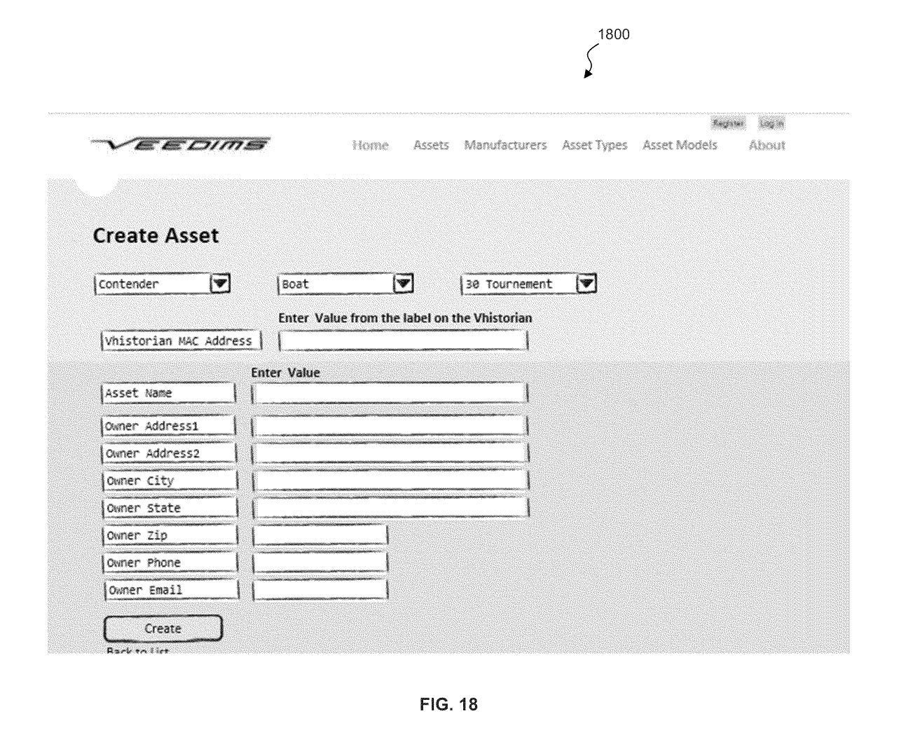

Second, there is the creation in the Vfleet PI Server of a PI Module Database structure for the new asset's Vhistorian PI Auto Point Sync interface, so that PI tag configuration can be kept synchronized between an asset's Vhistorian PI Server and the Vfleet PI Server. Note that when copies of the PI tags for an asset are created by PI APS on the Vfleet PI Server, the tags need to be uniquely named. Therefore, all of the Vfleet's set of PI tags will be using the Vhistorian's MAC address name (see GUI 1900 of FIG. 19). This is illustrated in FIG. 14 by step 1.1.

PI tag names for an asset on Vfleet will be of the form: newPIserverhostname.system.applicationname.group.variable. For example, 0E3A5DF6B4.Main.powerboard3.hss3.currentmult. This is illustrated by the GUI 1900 of FIG. 19.

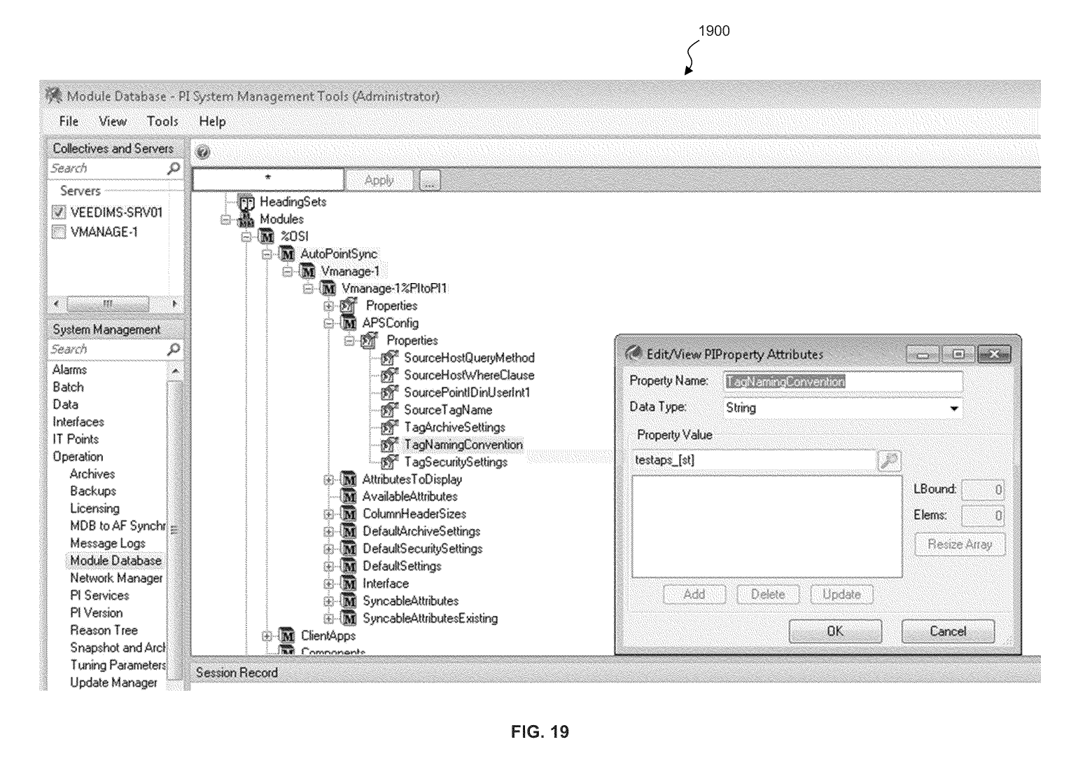

Third, there is the creation in the Vfleet's PI Module Database of a structure for the new asset's PItoPI interface so the PI tag values can start to be collected from the asset's Vhistorian. This is illustrated by a GUI 2000 of FIG. 20 and in FIG. 14 by step 1.1.

An asset's PI Server installation on an asset's Vhistorian should be as standard as possible so that cloning of a golden image can be performed. This is illustrated in FIG. 14 by step 2 and by step 904 of FIG. 9.

For example, the following OSIsoft PI products may be installed on an asset Vhistorian: PI Server Database (without PI AF), PI SDK 32 bit (used for automatic tag creation and digital set creation by the controller), PI Modbus Ethernet Interface (to collect data from the Veedims control system using Modbus Ethernet), PItoPI Interface (for communication to the VFleet PI Server with History Recovery mode to be used and set to a maximum time period that the vehicle will not be connected via Vlink), PItoPI APS (Auto Point Sync) (to keep vehicle PI tags synchronized with VFleet PI Server), PI System Management Tools, PI Process Book, and PI DataLink. As described below, with respect to PItoPI APS, it may be beneficial to delay the startup of this interface and PItoPI until the Vhistorian is registered with the VFleet PI Server.

As illustrated by step 906 of FIG. 9, independent of Vfleet registration, and at any time after cloning of the VHistorian computer's image, a number of changes need to be made to create a unique Vhistorian instance. These changes include the following. The computer is renamed so that the OSIsoft PI server becomes unique to the asset and to avoid any conflicts with other existing Vhistorian OSIsoft PI servers. The PI Server is added to the known servers table and set to be the default. The PI interface installation scripts are adjusted to use the new computer and PI Server names. A new PI APS (Auto Point Sync) directory is created using the PI Server name and the Access database point synchronization module database (mdb) file is copied in so that tag synchronization will be able to start. These changes are performed automatically and on reboot of the computer, and prior to allowing the computer to continue with starting its regular Services. The changes are made automatically by Window PowerShell Scripts (WPScripts).

More specifically, these changes involve the following. A check is made to see if a Vhistorian “startup configuration file” exists and, if so, whether the current computer name is the same as the name found in the configuration file. If the name is the same, then no renaming or changes are needed and a regular reboot can progress. If the name in the startup configuration file is different from that of the current computer name, then the following changes are made using the computer name found in the file.

Note that if the startup configuration file does not exist, a check is made to see whether the current computer's name is the same as its MAC address (minus the dashes as previously described). If it is not, the computer is renamed so that the OSIsoft PI Server is uniquely named. This is the same as the manual process of going to the computer Start, then right clicking on Computer, and selecting Properties, and then giving the computer a new name. It is noted that the use of a startup configuration file provides a way to manually intervene in the automatic renaming/change process in the cases where an asset Vhistorian needs to have a name other than its MAC address. This process is automatically performed as follows.

If the Vhistorian startup configuration file does not exist, then a WPScript is used to find the MAC address of the computer. The process removes the dashes from the MAC address to create a new unique name. For example, a new name may be in the form of 0E3A5DF6B4. Using this form of unique name avoids any conflict with existing PI Servers. The computer is renamed to this new name.

If the Vhistorian configuration file does exist and the current computer name is different from that found in the configuration file, the computer is renamed to the name found in the file.

After changing the name, a server reboot is performed.

Next, a WPScript and OSIsoft PI SDK is used to remove the “old” PI Server name from the clone image and add the new PI Server name (using the new computer name). Also, it makes the new PI Server the default PI Server.

Next, a WPScript is used to change the OSIsoft PI Modbus interface settings needed to communicate with the Vcontrol module as follows.

The ModbusE1.bat file is changed to reflect the new PI server host name: “C:\Program Files (x86)\PIPC\Interfaces\ModbusE\ModbusE.exe” 1/CN=1/POLLDELAY=0/PORT=502/RCI=30/TO=2/WRITEDELAY=0/PS=M /ID=5/host=0E3A5DF6B4:5450/dbuniint=66/maxstoptime=120/sio/perf=8/f=00:00:01,00:00:05.

Changes are now made to the OSIsoft interfaces installation settings used to communicate to the VFleet Server.

A WPScript is used to change the OSIsoft PItoPI1.bat file to reflect the new PI Server host name.

The PItoPI.bat file is changed to reflect the new source PI Server host name: “C:\Program Files (x86)\PIPC\Interfaces\PItoPEPItoPLexe” 1/src_host=0E3A5DF6B4:5450/TS/PS=PVH/ID=1/host=VEEDIMS-SRV01:5450/maxstoptime=120/PercentUp=100/sio/perf=8/f=5.

A WPScript is used to create a directory for the PI Auto Point Synch interface. The directory has a naming convention of: C:\Program Files (x86)\PIPC\APS\newsourcePIServerhostname_PItoPI1_destinationPIServername. For example, if there is one fixed destination PI Server for Vfleet called Veedims-srv01, then the directory would be named C:\Program Files(x86)\PIPC\APS\0E3A5DF6B4_PItoPI1_Veedims-srv01.

The WPScript then takes a copy of the PI APS Access database file called APSPoints.mdb from the original imaged directory called C:\Program Files (x86)\PIPC\APS\Cigarette-1_PItoPI1_Veedims-srv01 and pastes it into the newly created directory called: C:\Program Files (x86)\PIPC\APS\newsourcePIServerhostname PItoPI1_Veedims-srv01.

At this point, all OSIsoft product installation modifications are completed and the computer can now be allowed to progress with its regular boot and service startups.

When all of the OSIsoft product installation modifications are completed, then one of the services that is run automatically is the customized Vhistorian Vector PI Configuration Service. This is illustrated in FIG. 9 by step 908 and in FIG. 14 by step 3. This occurs as follows. On startup, the Vector PI Configuration Service reads the vector.xml file from the VScan server (step 910 of FIG. 9) and also reads and records a “check sum” value (step 912 of FIG. 9). The vector.xml structure contains all the details required for the Vector PI Configuration Service to build new local PI Tags, new local PI Digital State Sets (for any digital PI Tag types), and to make any edits to existing PI Tags or PI Digital State Sets (step 914 of FIG. 9).

It is noted that the PI Tag names for the Vhistorian level are of the form: system.applicationname.group.variable. For example, Main.powerboard3.hss3.currentmult.

Each field is built into the tag name by the Vcontrol. The “system” equals a vehicle system such as main, fuel, electrical, engine, etc., which will be more applicable in large vehicles. The “application name” equals a unique name given by the user to the module (e.g., a particular VIO module may be named “powerboard3.” The “group” equals a grouping of I/O by function. The “variable” equals an individual I/O value within the group.

The vector.xml file also contains the details required to build a representative “physical model” structure of the deployed system in the Vfleet PI AF Server. In other words, a PI AF structure is created that models or describes the physical asset's installed modules and associated I/O. This is illustrated in FIG. 9 by step 916 and in FIG. 14 by step 5.

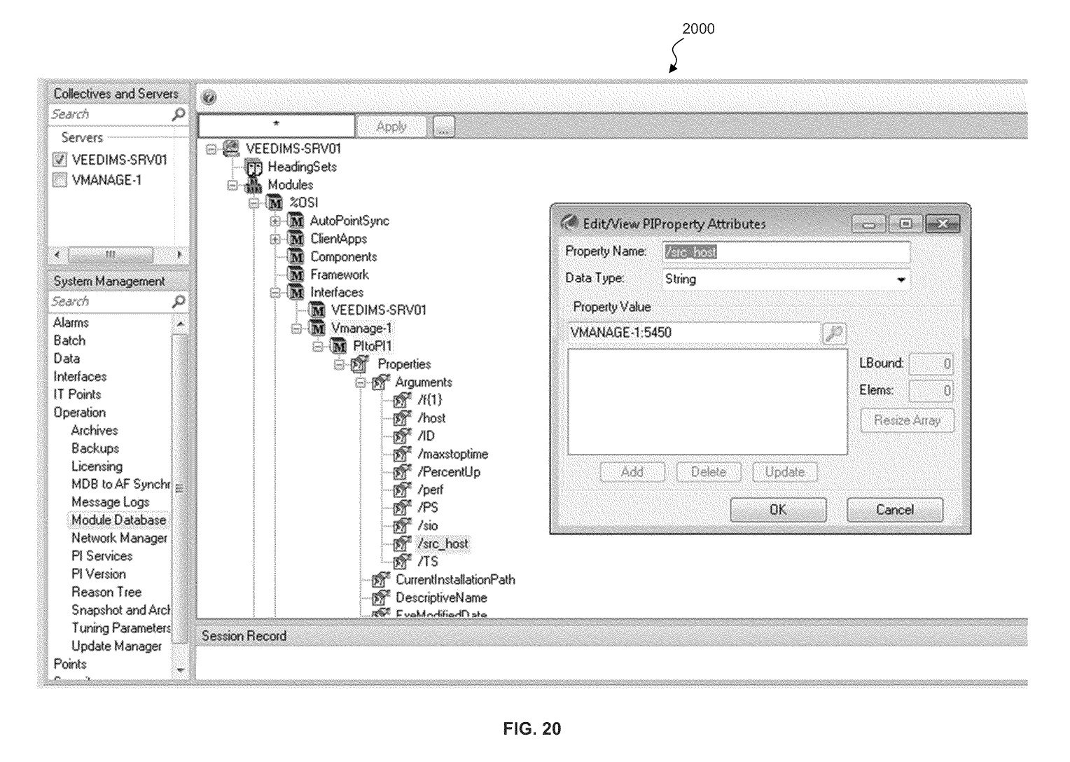

Referring to FIG. 21, a method 2100 illustrates one embodiment of the operation of the Vector Configuration Service after the initial values have been read. Accordingly, the Vector PI Configuration Service periodically reads a new check sum value from VScan in step 2102. If the check sum value has changed since the previous read as determined in step 2104, then there have been changes to the system and a new vector.xml file is read by the Vector PI Configuration Service (step 2106 of FIG. 21) and any new PI Tag and/or PI Digital States are created, and any changes to existing tags or states are made (step 2108 of FIG. 21).

In addition, if the check sum value has changed since the previous read, then this means that there may have been changes to the physical system and so the new physical model is read from the vector.xml file by the Vector PI Configuration Service (step 2106 of FIG. 21) and transformed into a PI AF xml structure ready for import to Vfleet (step 2108 of FIG. 21). The Vector PI Configuration Service then locates the asset's registration record in the Vfleet PI AF server and imports the PI AF xml structure for the asset.

After asset registration at the Vfleet level is done and after the Vhistorian installation changes are made, the asset local Vhistorian PI Server will startup. The local Vhistorian PI Modbus interface will startup. The Vhistorian Vector PI Configuration Service will startup and obtain the checksum from the VScan server and determine if it needs to process the vector.xml file to create or modify local PI Tags and create or modify PI Digital State Sets. It will then periodically scan for any change to the checksum to know when to make changes to the PI Tags, PI Digital State Sets, and/or the asset's PI AF physical model.

Any local Vhistorian PI Tags will begin to collect data values and store them in the Vhistorian PI Server. The local Vhistorian PI Auto Point Synch Engine service will be started and it will get its settings from the Vfleet module database changes made during registration. It will then create PI Tags and PI Digital State Sets on the Vfleet PI Server for the tags and digital state sets it finds for the new asset according to its configured tag synchronization rule set.

Note that the PI Auto Point Sync Engine is set to an eight hour synchronization cycle by default, but this can be changed as needed. Note also that this is a long time to wait to see if a new vehicle's tags are commissioned correctly, so a forced synchronization can be performed by stopping and starting the PI Auto Point Sync Engine Service. In some embodiments, at first install and connection to Vfleet, a sync may be forced through a reboot or through a startup script.

The PItoPI interface will connect with the Vfleet PI Server and wait for PI Tags that belong to it to be created, and then values will be sent in real time to the Vfleet PI Server. Next, the system will begin its normal steady state operations where data is collected and stored locally and the Vector PI Configuration Service and PI APS Interface Service will begin their periodic scans for any changes from VScan or to PI Tags respectively.

In another embodiment, a system includes a plurality of input/output (IO) modules, a scan module, a vector server, and an asset historian module. The IO modules are positioned within a structure. Each IO module includes a local server and is coupled to at least one component of the structure. Each IO module is configured to store values for variables of the coupled component in the IO module's local server and to generate a map file containing information about the variables. The scan module is positioned within the structure and coupled to the local servers and an aggregation server. The scan module is configured to access each local server and to store the values contained in each local server in the aggregation server. The vector server is positioned within the structure and coupled to the IO modules and the scan module. The vector server is configured to receive the map file from each IO module and to generate a vector file based on the map files. The vector file describes the variables for the plurality of IO modules and identifies a location for each of the values in a memory of the aggregation server. The asset historian module is positioned within the structure and coupled to the vector server and the aggregation server. The asset historian module contains a local historian database and is configured to generate a storage structure within the local historian database based on the vector file and to populate the storage structure with the values from the aggregation server.

In another embodiment, the system further includes a tag builder that is configured to automatically generate a tag for each of the variables based on the vector file, wherein a tag is a defined structure within the local historian database. In another embodiment, the tag builder is further configured to determine whether a change has occurred to the plurality of modules and, if a change has occurred, is configured to update the storage structure to reflect the change. In another embodiment, the tag builder is configured to determine whether the change has occurred by polling the vector server. In another embodiment, the tag builder is configured to determine whether the change has occurred by evaluating a checksum of the vector file. In another embodiment, only the scan module and the IO modules can directly access the local servers. In another embodiment, the scan module provides an application programming interface for access to the aggregation server because access to a value within the aggregation server requires knowledge of a location of the value in the memory of the aggregation server, and wherein the scan server is configured to receive a query for a variable name from an application, match the variable name to the location of the corresponding value in the memory of the aggregation server, and to return the value to the application. In another embodiment, the scan module is configured to provide an event subscription interface, wherein a change in a value stored in a local server that corresponds to a subscribed event is published by the scan module to any subscriber of the subscribed event. In another embodiment, a system definition file defines a behavior of the vector server and the scan module. In another embodiment, the system definition file defines which of the variables for the IO modules should be described in the vector file. In another embodiment, the system definition file defines which of the values contained in each local server should be stored in the aggregation server. In another embodiment, the system further includes a fleet historian module positioned outside of the structure, wherein the fleet historian module contains a fleet historian database that contains information from the storage structures of a plurality of structures.

In still another embodiment, a method for managing data for a structure is provided. The method includes generating a plurality of map files by a corresponding plurality of IO modules positioned within the structure. Each IO module is coupled to at least one component of the structure. The map file generated by each IO module contains information about variables corresponding to the component coupled to the IO module. A vector file is generated from the plurality of map files. The vector file describes the variables and identifies where a value for each variable is located in a memory of an aggregation server positioned within the structure. A local data structure for the structure is automatically created in a local historian database positioned within the structure using the variables in the vector file. The local data structure is populated with the values from the aggregation server. The local data structure is automatically updated as changes occur to the vector file and the values.

In another embodiment, the method further includes storing the value for each of the variables in the aggregation server, wherein the storing includes: retrieving the value from the IO module corresponding to the component coupled to the IO module; and storing the value in the aggregation server. In another embodiment, the method further includes creating a physical model structure of the structure using the vector file and the values; and sending the physical model structure to a fleet historian that is located outside of the structure. In another embodiment, the method further includes using a system definition file to control which of the variables are described in the vector file.

In yet another embodiment, a method for installing a data management system for a plurality of structures is provided. The method includes creating a registration for each of the structures at a fleet level. A cloned image of a local information management structure is created on each of the structures. The cloned image of the local information management structure is modified on each of the structures to make the local information management structure on each structure unique to that structure. A plurality of data points needed for each local information management structure are automatically generated based on a vector file generated within the structure corresponding to the local information management structure. The vector file describes a plurality of modules positioned within the structure, a plurality of variables corresponding to each of the modules, and a location of each of a plurality of values corresponding to the variables. Each of the local information management structures is populated with the values from the structure corresponding to the local information management structure. Each of the local information management structures is linked with the registration of the structure corresponding to the local information management structure.

In another embodiment, the method further includes creating a fleet information management structure that contains data from the local information management structures of each structure. In another embodiment, the method further includes importing a physical model structure of each structure into the fleet information management structure. In another embodiment, the physical model structure contains context information for each data point, and the context information is not stored in the local information management structures.

It will be appreciated by those skilled in the art having the benefit of this disclosure that this system and method for device control, monitoring, data gathering and data analytics over a network provides a way to obtain, organize, and analyze large amounts of asset specific data. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A system comprising:
a plurality of input/output (IO) modules positioned within a vehicle, wherein each IO module includes a local server and is coupled to at least one component of the vehicle, and wherein each IO module is configured to store values for variables of the coupled component in the IO module's local server and to generate a map file containing information about the variables;
a scan module positioned within the vehicle and coupled to the local servers and an aggregation server, wherein the scan module is configured to access each local server and to store the values contained in each local server in the aggregation server;
a vector server positioned within the vehicle and coupled to the IO modules and the scan module, wherein the vector server is configured to receive the map file from each IO module and to generate a vector file based on the map files, and wherein the vector file describes the variables for the plurality of IO modules and identifies a location for each of the values in a memory of the aggregation server; and
an asset historian module positioned within the vehicle and coupled to the vector server and the aggregation server, wherein the asset historian module contains a local historian database, and wherein the asset historian module is configured to generate a storage structure within the local historian database based on the vector file and to populate the storage structure with the values from the aggregation server.

2. The system of claim 1 further comprising a tag builder that is configured to automatically generate a tag for each of the variables based on the vector file, wherein a tag is a defined structure within the local historian database.

3. The system of claim 2 wherein the tag builder is further configured to determine whether a change has occurred to the plurality of modules and, if a change has occurred, is configured to update the storage structure to reflect the change.

4. The system of claim 3 wherein the tag builder is configured to determine whether the change has occurred by polling the vector server.

5. The system of claim 3 wherein the tag builder is configured to determine whether the change has occurred by evaluating a checksum of the vector file.

6. The system of claim 1 wherein only the scan module and the IO modules can directly access the local servers.

7. The system of claim 1 wherein the scan module provides an application programming interface for access to the aggregation server because access to a value within the aggregation server requires knowledge of a location of the value in the memory of the aggregation server, and wherein the scan server is configured to receive a query for a variable name from an application, match the variable name to the location of the corresponding value in the memory of the aggregation server, and to return the value to the application.

8. The system of claim 1 wherein the scan module is configured to provide an event subscription interface, wherein a change in a value stored in a local server that corresponds to a subscribed event is published by the scan module to any subscriber of the subscribed event.

9. The system of claim 1 wherein a system definition file defines a behavior of the vector server and the scan module.

10. The system of claim 9 wherein the system definition file defines which of the variables for the IO modules should be described in the vector file.

11. The system of claim 9 wherein the system definition file defines which of the values contained in each local server should be stored in the aggregation server.

12. The system of claim 1 further comprising a fleet historian module positioned outside of the vehicle, wherein the fleet historian module contains a fleet historian database that contains information from the storage structures of a plurality of vehicles.

13. A method for managing data for a vehicle comprising:
generating a plurality of map files by a corresponding plurality of IO modules positioned within the vehicle, wherein each IO module is coupled to at least one component of the vehicle, and wherein the map file generated by each IO module contains information about variables corresponding to the component coupled to the IO module;
generating a vector file from the plurality of map files, wherein the vector file describes the variables and identifies where a value for each variable is located in a memory of an aggregation server positioned within the vehicle;
automatically creating a local data structure for the vehicle in a local historian database positioned within the vehicle using the variables in the vector file;
populating the local data structure with the values from the aggregation server; and
automatically updating the local data structure as changes occur to the vector file and the values.

14. The method of claim 13 further comprising storing the value for each of the variables in the aggregation server, wherein the storing includes:
retrieving the value from the IO module corresponding to the component coupled to the IO module; and
storing the value in the aggregation server.

15. The method of claim 13 further comprising:
creating a physical model structure of the vehicle using the vector file and the values; and
sending the physical model structure to a fleet historian that is located outside of the vehicle.

16. The method of claim 13 further comprising using a system definition file to control which of the variables are described in the vector file.

17. A method for installing a data management system for a plurality of vehicles comprising:
creating a registration for each of the vehicles at a fleet level;
creating a cloned image of a local information management structure on each of the vehicles;
modifying the cloned image of the local information management structure on each of the vehicles to make the local information management structure on each vehicle unique to that vehicle;
automatically generating a plurality of data points needed for each local information management structure based on a vector file generated within the vehicle corresponding to the local information management structure, wherein the vector file describes a plurality of modules positioned within the vehicle, a plurality of variables corresponding to each of the modules, and a location of each of a plurality of values corresponding to the variables;
populating each of the local information management structures with the values from the vehicle corresponding to the local information management structure; and
linking each of the local information management structures with the registration of the vehicle corresponding to the local information management structure.

18. The method of claim 17 further comprising creating a fleet information management structure that contains data from the local information management structures of each vehicle.

19. The method of claim 18 further comprising importing a physical model structure of each vehicle into the fleet information management structure.

20. The method of claim 19 wherein the physical model structure contains context information for each data point, and wherein the context information is not stored in the local information management structures.
